(19) United States
(12) Patent Application Publication
(10) Pub. No.: US 2019/0110529 A1
(43) Pub. Date: Apr. 18, 2019

(54) COMPOSITE TEXTILE SHEET, DISPOSABLE TEXTILE PRODUCT USING COMPOSITE TEXTILE SHEET, GLOVE, RAINCOAT, AND METHOD FOR MANUFACTURING DISPOSABLE TEXTILE PRODUCT

(71) Applicant: Kikuo YAMADA, Shinagawa-ku (JP)

(72) Inventor: Kikuo YAMADA, Shinagawa-ku (JP)

(21) Appl. No.: 16/094,090

(22) PCT Filed: Apr. 21, 2017
(86) PCT No.: PCT/JP2017/016110

§ 371 Date: Oct. 16, 2018

Related U.S. Application Data
(60) Provisional application No. 62/329,263, filed on Apr. 29, 2016.
(60) Provisional application No. 62/327,372, filed on Apr. 25, 2016.

(30) Foreign Application Priority Data
May 13, 2016 (JP) PCT/JP2016/064247
Nov. 11, 2016 (JP) 2016-221066

(51) Int. Cl. A41D 3/04; B32B 5/02; B32B 27/10; B32B 7/14; B32B 27/12; B32B 27/32; A41D 19/00; D06M 17/00; A41B 9/00; A41B 17/00

(52) U.S. Cl. CPC A41D 3/04; A41B 2400/62; B32B 27/10; B32B 7/14; B32B 27/12; B32B 27/32; A41D 19/0006; D06M 17/00; A41B 9/004; A41B 17/00; A41D 2400/52; A41D 2400/62; B32B 2307/726; B32B 2307/724; B32B 2437/00; B32B 2437/02; A41D 2300/332; D10B 2501/04; D10B 2501/041; D10B 2321/021; D10B 2401/02; A41D 2200/20; A41B 2400/52; B32B 5/022

(57) ABSTRACT

Provided is a composite textile sheet that can be used as a fabric for manufacturing a disposable textile product that exhibits an excellent moisture transpiration property and does not cause a stuffy feeling or sticky feeling when worn. Also provided are a disposable textile product that uses the composite textile sheet, a glove and a raincoat as a disposable textile product, and a method for manufacturing a disposable textile product.

A composite textile sheet 1 is made from a multi-ply sheet 15 that is formed by laminating a textile sheet 2 or 3 having air permeability and a textile material sheet 4 having liquid diffusibility. The textile sheet 2 or 3 and the textile material sheet 4 are in mutual contact, and in a plane of mutual contact, a bonded region 30 in which the textile sheet and the textile material sheet are bonded, and a non-bonded region 8 in which the textile sheet and the textile material sheet are not bonded, are formed. The non-bonded region 8 includes a space section 9. A moisture transpiration path is formed, and, through the moisture transpiration path, the space section 9, a textile gap of the textile sheet 2 or 3, and a textile gap of the textile material sheet 4 mutually communicate.

### TECHNICAL FIELD

The present invention relates to a composite textile sheet, a disposable textile product that uses the composite textile sheet, a glove, a raincoat, and a method for manufacturing a disposable textile product.

### BACKGROUND ART

Ordinarily, a so-called disposable product that is used once or multiple times and then discarded is widely used in clothing such as an undergarment, a shirt, a diaper, a glove, and a raincoat, and these products are growing in widespread popularity for use in areas such as for home use and medical care. Fabrics used in the disposable product are often fabrics which use a nonwoven fabric or a synthetic resin sheet as a main material, and these fabrics exhibit merits of being lightweight and easy to process. However, on the other hand, disposable products that use these fabrics are inferior in terms of the moisture transpiration property, and are also inferior in terms of comfort when worn including causing a stuffiness when used for an extended period of time, or causing stickiness on the skin by sweat and other body fluids. While there have been many technical proposals relating to improving the air permeability of fabrics for disposable products, currently, moisture transpiration property is not being sufficiently examined.

In the related art, several clothing goods have been proposed that use a composite formed by laminating a nonwoven fabric, a porous film, and staple fibers using an adhesive, and thus are imparted with air permeability and resistance to liquid. For example, the Patent Document 1 describes a composite sheet formed by laminating a surface web made from a nonwoven fabric, a microporous film, and an internal web made from cotton. In addition, several pants-type disposable diapers have also been proposed as a disposable textile product. For example, the Patent Document 2 describes a pants-type disposable diaper made from an exterior member and an absorbent body, with the absorbent body connected in a detachable manner to a crotch part of the exterior member.

### CITATION LIST

### Patent Document

Patent Document 1: WO 96/09165, pamphlet
Patent Document 2: JP 2008-104503A

### SUMMARY OF INVENTION

### Technical Problem

While the composite sheet described by Patent Document 1 has a microporous film, the composite sheet does not exhibit a sufficient moisture transpiration property. In addition, with respect to the pants-type disposable diaper described in Patent Document 2, the exterior member is formed from a nonwoven fabric, and is therefore inferior in terms of the moisture transpiration property, and has problems such as causing stuffiness or stickiness to the skin due to sweat and other body fluids. Patent Document 2 also discloses that a stretchable material is disposed around the waist, abdomen, and legs of the pants-type disposable diaper, and the fit feeling on the wearer is thereby improved. However, a significant amount of stretchable material is used, and the stretchable material around the legs in particular is disposed in a curved manner, leading to problems of the manufacturing not being easy and costs being incurred.

The present invention was developed in order to realize a disposable textile product that exhibits an excellent moisture transpiration property and does not cause a stuffiness or sticky feeling when worn, and an object of the present invention is to provide a composite textile sheet that can be used as a fabric for manufacturing a disposable textile product that does not cause a stuffiness or a stickiness. Another object of the present invention is to provide a disposable textile product that uses the composite textile sheet and exhibits an excellent moisture transpiration property. Yet another object of the present invention is to provide a glove and a raincoat as a disposable textile product having an excellent moisture transpiration property. In addition, another object of the present invention is to provide a manufacturing method that can be used to easily and inexpensively manufacture a disposable textile product.

### Solution to Problem

The present invention provides the following to solve the problems above.

(1) A composite textile sheet including a multi-ply sheet that is formed by laminating a textile sheet having air permeability and a textile material sheet having liquid diffusibility; wherein the textile sheet and the textile material sheet are in mutual contact; in a plane of mutual contact, a bonded region in which the textile sheet and the textile material sheet are bonded, and a non-bonded region in which the textile sheet and the textile material sheet are not bonded, are formed; the non-bonded region includes a space section; and a moisture transpiration path is formed, and through the moisture transpiration path, the space section, a textile gap of the textile sheet, and a textile gap of the textile material sheet mutually communicate.

(2) A disposable textile product formed using the composite textile sheet described in (1).

(3) A glove as the disposable textile product described in (2), wherein the glove is formed by bonding: a first composite textile sheet for a glove, formed by laminating a first textile sheet, the textile material sheet, an elastic member, and a second textile sheet; and a second composite textile sheet for a glove, formed by laminating the first textile sheet, the textile material sheet, and the second textile sheet.

(4) A raincoat as the disposable textile product described in (2), wherein the raincoat is formed by bonding: a first composite textile sheet for a raincoat, formed by laminating the first textile sheet, the elastic member, the textile material sheet, and a moisture permeable film; and a second composite textile sheet for a raincoat, obtained by laminating the first textile sheet, the textile material sheet, and the moisture permeable film.

(5) A method for manufacturing a disposable textile product, the method including the steps of: manufacturing a first composite textile sheet by supplying each of a textile sheet having air permeability and a textile material sheet having liquid diffusibility, and partially bonding the sheets through a bonding means to form a multi-ply sheet; manufacturing a second composite textile sheet by a similar step as described above; bonding the first composite textile sheet and the second composite textile sheet; and cutting to a prescribed shape at the same time as bonding or after bonding.

### Advantageous Effect of Invention

The composite textile sheet according to an embodiment of the present invention has an excellent moisture transpiration property, and can be favorably used as a fabric for a disposable textile product. In addition, a disposable textile product that uses the composite textile sheet according to an embodiment of the present invention exhibits an advantageous effect of providing a comfortable wear feeling without causing stuffiness or stickiness during use. Furthermore, the glove and raincoat according to an embodiment of the present invention do not lead to sweaty skin or heat accumulation even when worn for an extended period of time, and have an advantageous effect of being able to improve product value as a disposable glove and as a disposable raincoat. Moreover, the method for manufacturing a disposable textile product according to an embodiment of the present invention provides an advantageous effect of enabling the easy and economical manufacture of a disposable textile product provided with an unprecedented characteristic of having an excellent moisture transpiration property.

### BRIEF DESCRIPTION OF DRAWINGS

FIGS. 1A and 1B are vertical cross-sectional views of a composite textile sheet according to a first embodiment of the present invention.

FIG. 2 is a vertical cross-sectional view of a composite textile sheet for which the adhesion position of an adhesive is shifted.

FIG. 3 is a view illustrating a state in which the composite textile sheet is used in disposable underpants.

FIG. 4 is schematic view for describing the steps for manufacturing the composite textile sheet.

FIG. 5 is a flowchart for describing the method for manufacturing the composite textile sheet.

FIG. 6 is a schematic view illustrating an adhesive application device.

FIGS. 7A and 7B are schematic views for describing a folding treatment.

FIGS. 8A, 8B, and 8C are schematic views for describing processing from a hole formation treatment to a bonding treatment.

FIG. 9 is a plan view illustrating a composite textile sheet according to a second embodiment of the present invention.

FIG. 10 is a view for describing a shirring portion of the composite textile sheet of FIG. 9.

FIG. 11 is an enlarged view of the composite textile sheet of FIG. 9.

FIG. 12 is a cross-sectional view along the line A-A of FIG. 11.

FIG. 13 is a cross-sectional view along the line B-B of FIG. 11.

FIGS. 14A and 14B are views illustrating an example of a glove as a disposable textile product that uses a composite textile sheet; FIG. 14A is a view of the glove viewed from one side, and FIG. 14B is a view of the glove viewed from the other side.

FIG. 15 is a view illustrating an aspect of a universal glove that uses a composite textile sheet.

FIG. 16 is a schematic view illustrating an example of the steps for manufacturing a glove that uses the composite textile sheet.

FIG. 17 is a flowchart illustrating an example of a method for manufacturing a glove that uses the composite textile sheet.

FIG. 18 is a view illustrating an aspect of a raincoat that uses a composite textile sheet.

FIG. 19 is a schematic view illustrating an example of the steps for manufacturing a raincoat that use the composite textile sheet.

FIGS. 20A and 20B are views illustrating an aspect of disposable underwear that uses a composite textile sheet; FIG. 20A is a view for a case where the wearer is viewed from the back, and FIG. 20B is a view for a case where the wearer is viewed from the side.

FIG. 21 is a schematic view illustrating an example of the steps for manufacturing disposable underpants that use the composite textile sheet.

FIG. 22 is a vertical cross-sectional view of a composite textile sheet for which the adhesion position of an adhesive is made uniform.

FIGS. 23A and 23B are schematic cross-sectional views for describing one aspect for a case where the composite textile sheet of the present invention is provided with a moisture permeable film.

FIG. 24 is a cross-sectional view illustrating another aspect of the composite textile sheet of the second embodiment of the present invention, and is a cross-sectional view corresponding to the cross-section of FIG. 13.

FIG. 25 is a graph illustrating the relationship between the numeric value for the transpiration ratio (%) and the elapsed time for Examples 1 to 4 and Comparative Example 1 shown in Table 1.

### DESCRIPTION OF EMBODIMENT

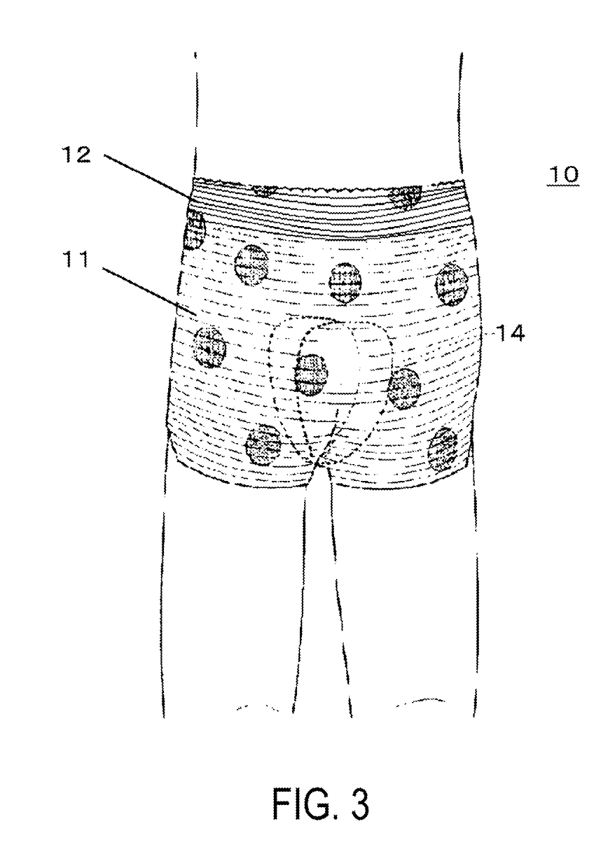

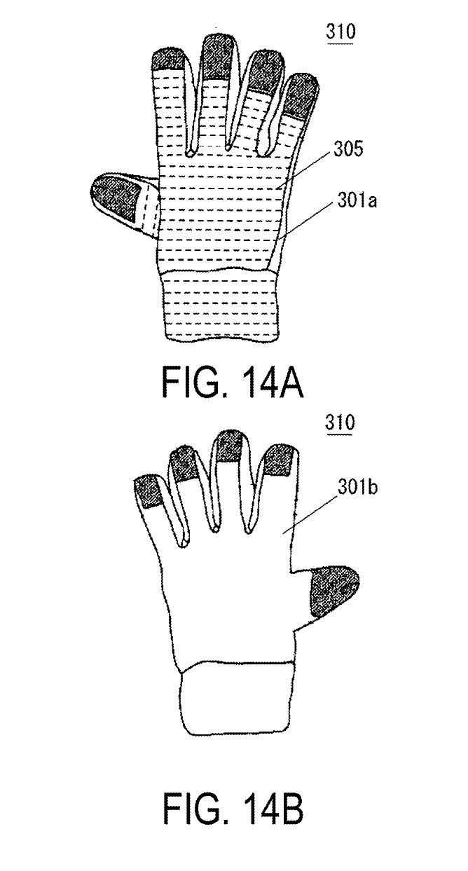

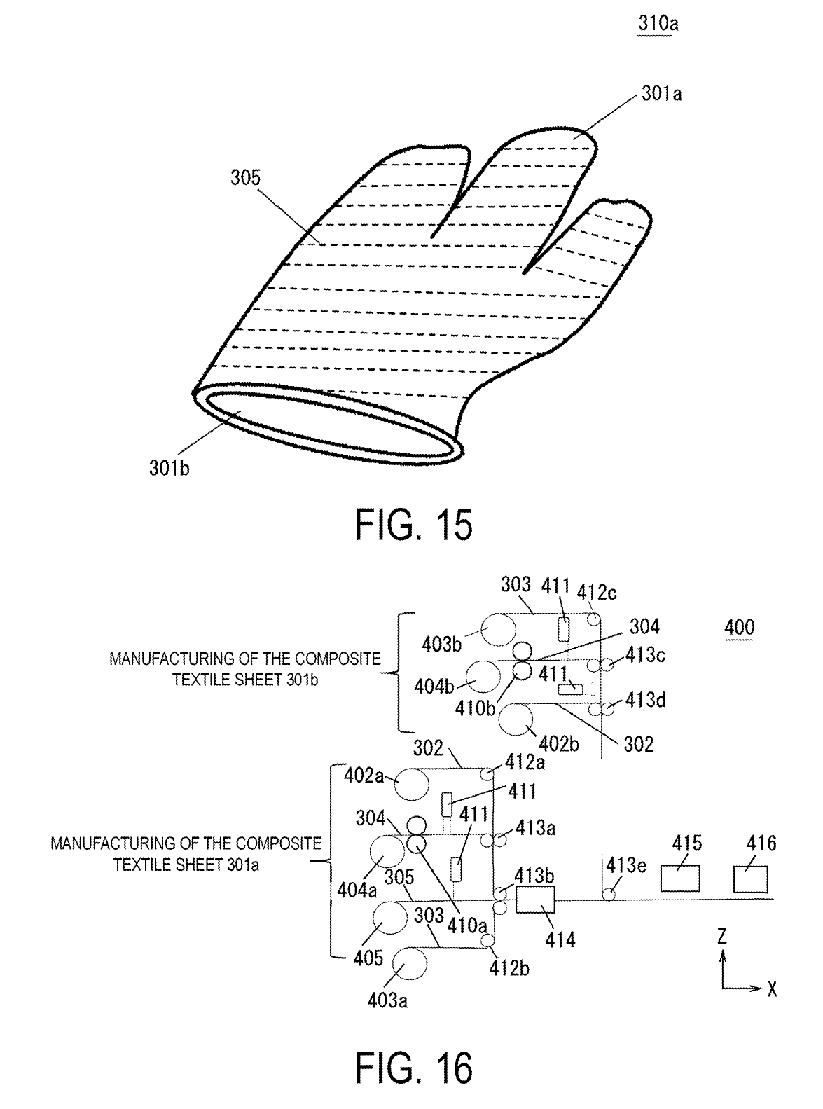

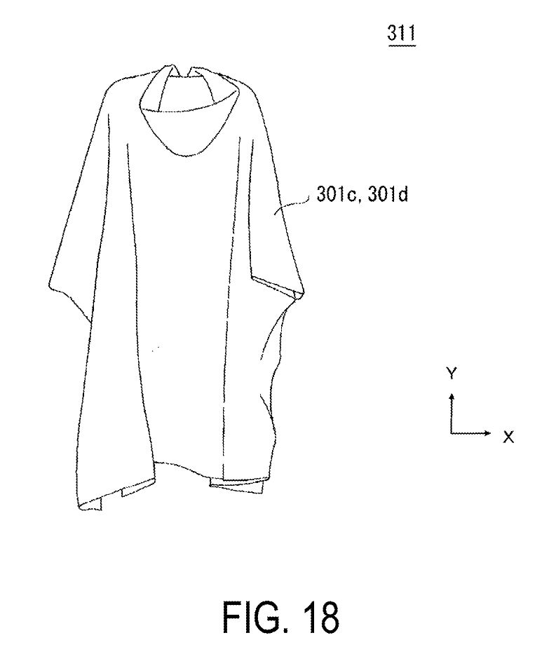

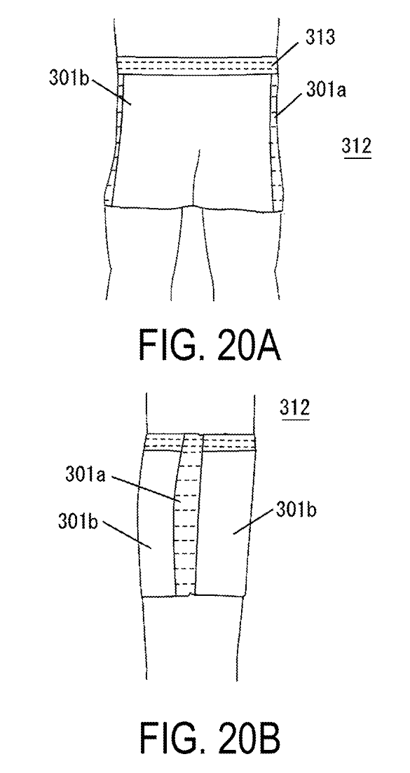

Embodiments of the present invention will be explained below with reference to the drawings. However, the embodiments described herein are merely examples of the implementation of the present invention, and the present invention is not restricted in any way by the matters described in the following embodiments. A composite textile sheet 1 of the present embodiment can be applied as a fabric for various disposable textile products. Examples of disposable textile products that can use the composite textile sheet 1 include gloves 310, 310a (see FIGS. 14 and 15), a raincoat 311 (see FIG. 18), and underpants 10, 312 (see FIGS. 3 and 20) as described below, as well as disposable garments such as underwear other than underpants, socks, and work clothes; bedding articles such as pajamas, pillowcases, sheets, and futon covers; covers for furnitures such as chairs, and sofas; covers for miscellaneous goods such as cushions, flat floor cushions, boxed tissues, and toilet seats; covers for vehicle seats and steering wheels, etc.; daily necessities such as towels, handkerchiefs, masks, mats, and aprons; packaging sheets for various goods, bags, satchels, and curtains. However, the present invention is not limited to these.

### First Embodiment

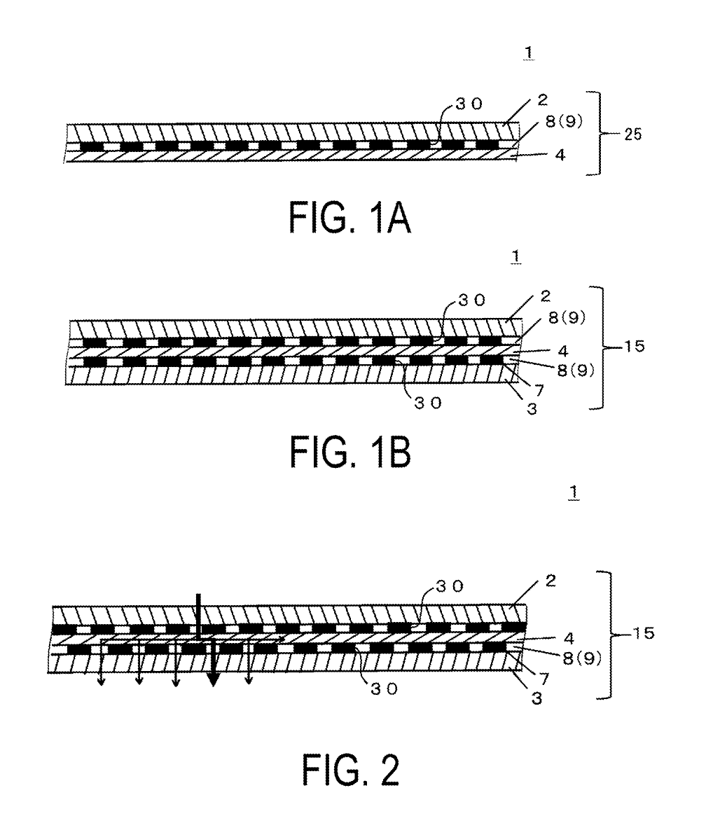

The composite textile sheet 1 according to a first embodiment of the present invention is described. FIG. 1B is a vertical cross-sectional view of the composite textile sheet 1 according to the present embodiment. In FIG. 1B, the composite textile sheet 1 is configured of a multi-ply sheet 15 which includes: a first textile sheet 2 having air permeability, a second textile sheet 3 likewise having air permeability, and a textile material sheet 4 which is interposed between the first and second textile sheets 2, 3 and has liquid diffusibility, the multi-ply sheet 15 being formed by laminating the first and second textile sheets 2, 3 and the textile material sheet 4. The first and second textile sheets 2, 3 constitute a fiber layer having air permeability, and the textile material sheet 4 constitutes a fiber layer having liquid diffusibility. The composite textile sheet 1 is configured from three layers in this manner.

FIG. 1B illustrates an aspect in which the textile sheet includes the first textile sheet 2 and the second textile sheet 3, but as another aspect, the textile sheet may include only one layer as illustrated in FIG. 1A. That is, either the first textile sheet 2 or the second textile sheet 3 may be omitted, and the textile sheet may be configured as a composite textile sheet 1 made from two layers including the textile sheet 2 or 3 and the textile material sheet 4. In the example of FIG. 1A, the composite textile sheet 1 is formed from a two-layer multi-ply sheet 25 formed by laminating the first textile sheet 2 and the textile material sheet 4.

The composite textile sheet 1 illustrated in FIGS. 1A and 1B may be further layered with a moisture permeable film 70. The moisture permeable film refers to a film material that allows the passage of a gas (air) or water vapor, but does not allow the passage of liquids such as water.

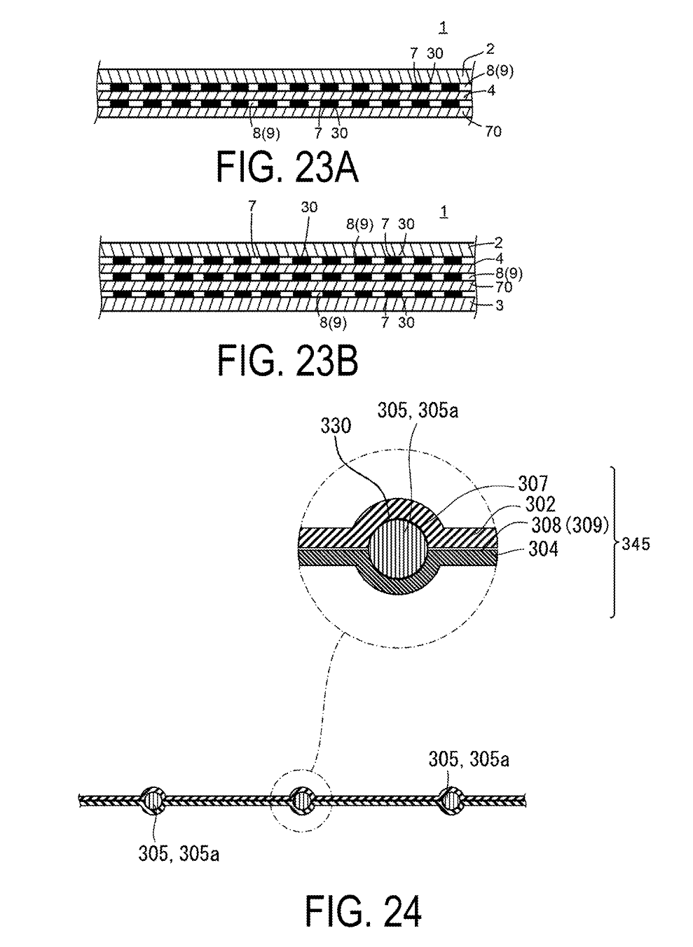

In the composite textile sheet 1, the moisture permeable film 70 is preferably layered at a position directly facing the textile material sheet 4. With such a configuration, the escape of liquid outwardly from the textile material sheet 4 can be more effectively suppressed while ensuring that a moisture transpiration function is exhibited by the multi-layered structure of the first textile sheet 2 and the textile material sheet 4. At this time, from the perspective of ensuring that the moisture transpiration function is exhibited by the multi-layered structure of the first textile sheet 2 and the textile material sheet 4, the moisture permeable film 70 is preferably layered to avoid a position directly facing the first textile sheet 2, which is slated to be positioned at the skin surface side. Therefore, in a case where the composite textile sheet 1 has three layers including the first and second textile sheets 2, 3 and the textile material sheet 4, the composite textile sheet 1 preferably has the moisture permeable film 70 interposed between the second textile sheet 3 and the textile material sheet 4 as illustrated in FIG. 23B.

Furthermore, in a composite textile sheet 1 having a two-layer configuration of the first textile sheet 2 or the second textile sheet 3, and the textile material sheet 4, in a case where the moisture permeable film 70 is layered, as illustrated in FIG. 23A, the moisture permeable film 70 is layered to a surface of the textile material sheet 4 that is opposite the textile sheet bonding surface (that is, to an outer surface side of the textile material sheet 4).

In FIG. 23A, a case is illustrated in which, between the first and second textile sheets 2, 3, the second textile sheet 3 is omitted from the multi-ply sheet described by FIG. 1B. However, as yet another embodiment, for a case where the first textile sheet 2 of the first and second textile sheets 2, 3 is omitted from the multi-ply sheet described by FIG. 1B, if the moisture permeable film 70 is layered, the moisture permeable film 70 is layered to a surface of the textile material sheet 4 that is opposite the textile sheet bonding surface (that is, to an outer surface side of the textile material sheet 4) (not illustrated).

In an embodiment in which the composite textile sheet 1 is configured as a composite textile sheet made from two layers including the first textile sheet 2 or the second textile sheet 3, and the textile material sheet 4, the first textile sheet 2 or the second textile sheet 3 and the textile material sheet 4 are in mutual contact. In this type of plane of mutual contact between the textile sheet and the textile material sheet, the first or second textile sheet 2 or 3 and the textile material sheet 4 are partially bonded by an adhesive. At this time, a bonded region in which the first textile sheet 2 or the second textile sheet 3 and the textile material sheet 4 are bonded, and a non-bonded region in which these are not bonded are formed, and the non-bonded region includes a space section.

For example, in a case where the first textile sheet 2 and the textile material sheet 4 illustrated in FIG. 1A are layered, the first textile sheet 2 and the textile material sheet 4 are in contact. The bonded region 30 and the non-bonded region 8 are formed by bonding the first textile 2 and the textile material sheet 4 with an adhesive 7. Furthermore, the non-bonded region 8 includes a space section 9. With a composite textile sheet configured in this manner, a moisture transpiration path is formed, and through the moisture transpiration path, the space section 9, a textile gap of the first textile sheet 2 or the second textile sheet 3, and a textile gap of the textile material sheet 4 mutually communicate.

Note that cases in which the “first textile sheet 2 or the second textile sheet 3” and the textile material sheet 4 are in contact include both a case where the “first textile sheet 2 or the second textile sheet 3” and the textile material sheet 4 are in contact directly, and a case where the “first textile sheet 2 or the second textile sheet 3” and the textile material sheet 4 are in contact indirectly with an adhesive interposed therebetween.

In an embodiment in which the moisture permeable film 70 is provided so as to face the textile material sheet 4, the bonding of the moisture permeable film 70 is also partial bonding, and in the plane of mutual contact between the textile material sheet 4 and the moisture permeable film 70, a bonded region 30 where the textile material sheet 4 and the moisture permeable film 70 are bonded, and a non-bonded region 8 where these are not bonded are formed, and the non-bonded region 8 includes a space section 9. Similar to the formation of the bonded region 30 between the first textile sheet 2 or the second textile sheet 3 and the textile material sheet 4, the bonded region 30 where the textile material sheet 4 and the moisture permeable film 70 are bonded can be formed using the adhesive 7.

As illustrated in FIG. 1B, for a case where the composite textile sheet 1 is formed as a three-layer structure by laminating the first textile sheet 2, the textile material sheet 4, and the second textile sheet 3, the first textile sheet 2 and the textile material sheet 4 are in mutual contact. In the plane of mutual contact between the first textile sheet 2 and the textile material sheet 4, the first textile sheet 2 and the textile material sheet 4 are partially bonded by the adhesive 7. Thus, the bonded region 30 and non-bonded region 8 where the first textile sheet 2 and the textile material sheet 4 are not bonded are formed, and the non-bonded region 8 includes a space section 9. Likewise, the second textile sheet 3 and the textile material sheet 4 are in mutual contact, and in the plane of mutual contact between the second textile sheet 3 and the textile material sheet 4, the second textile sheet 3 and the textile material sheet 4 are partially bonded by the adhesive 7. Thus, the bonded region 30 and non-bonded region 8 where the second textile sheet 3 and the textile material sheet 4 are not bonded are formed, and the non-bonded region 8 includes a space section 9.

Furthermore, in the composite textile sheet 1 configured in this manner, a moisture transpiration path is formed, and through the moisture transpiration path, the space section 9 formed in the non-bonded region 8 in the plane of mutual contact between the first textile sheet 2 and the textile material sheet 4, the space section 9 formed in the non-bonded region 8 in the plane of mutual contact between the second textile sheet 3 and the textile material sheet 4, the textile gap of the first textile sheet 2, the textile gap of the second textile sheet 3, and textile gap of the textile material sheet 4 mutually communicate. In an embodiment in which the moisture permeable film 70 is provided so as to face the textile material sheet 4, a portion of the moisture permeable film 70 through which water vapor passes is further added to the moisture transpiration path.

The above-described moisture transpiration path is formed in the composite textile sheet 1, and therefore the composite textile sheet 1 can exhibit an excellent moisture transpiration property through the action of these moisture transpiration paths. In addition, heat dissipation and moisture permeability of the composite textile sheet 1 can also be improved by the formation of the moisture transpiration path. In an embodiment in which the moisture permeable film is layered to the outer surface side, the moisture permeable film does not allow the passage of liquid such as water, but does allow the passage of water vapor, and therefore in embodiments provided with the moisture permeable film as well, the moisture transpiration property can likewise be improved. In addition, forming the above-described moisture transpiration path can also improve the heat dissipation and moisture permeability of the composite textile sheet 1.

The composite textile sheet 1 is suitable as a fabric for manufacturing a disposable textile product (for example, a glove, raincoat, underpants, and sheet). For a case where sweat or other such body fluids are emanated from the body when a disposable textile product is worn on the body, the body fluids pass from the first textile sheet 2 side that is in contact with the skin surface and through the moisture transpiration path of the composite textile sheet 1, and are transpired externally while being diffused within the textile material sheet 4. For a case where the composite textile sheet 1 is a multi-ply sheet of the first textile sheet 2, the textile material sheet 4, and the second textile sheet 3, as illustrated by the arrows of FIG. 22, while the body fluids pass from the first textile sheet 2 side that is in contact with the skin surface and through the moisture transpiration path of the composite textile sheet 1, the body fluids are diffused within the textile material sheet 4, and advance further in the moisture transpiration path of the composite textile sheet 1, and thereby move to the second textile sheet 3, and are transpired outward from the surface of the second textile sheet 3. The moisture transpiration path in this case is formed by a path from the textile gap of the first textile sheet 2→the space section 9 of the non-bonded region 8→the textile gap of the textile material sheet 4→the space section 9 of the non-bonded region 8→and the textile gap of the second textile sheet 3. Note that when applying the composite textile sheet 1 to a disposable textile product, the product may be formed such that the first textile sheet 2 is at a side that contacts the skin of the user (skin surface side), and the second textile sheet 3 is at the non-skin surface side, or may be formed such that these positions are reversed. The body fluids above refer to a concept that includes sweat, as well as fluids such as urine, blood, and lymph fluid.

The composite textile sheet 1 has moisture transpiration path in this manner, and therefore can exhibit excellent moisture transpiration property, and can improve comfort during use of a disposable textile product when the product is worn, without causing a stuffiness or stickiness due to sweat or other such body fluids. As will be described below, in the present embodiment, the first textile sheet 2 and the second textile sheet 3 include a nonwoven fabric material, and the textile material sheet 4 include a paper material. A paper material excels in liquid diffusibility and in moisture transpiration property, but if a fabric for a disposable textile product is formed from only a paper material, the disposable textile product cannot be provided for practical use. This is because when configured only of a paper material, the product easily disintegrates when moisture is absorbed. However, an effect of the present embodiment can be exhibited when laminating a paper material to a nonwoven fabric material. Note that in the present specification, the term paper material refers to a material that is manufactured by agglutinating or using a binder to bind plant fibers containing a cellulose-based component or fibers other than plant fibers. More specifically, examples of paper materials include tissue paper, crepe paper and airlaid nonwoven fabrics. The paper material may also contain other materials in addition to the fiber material, and materials containing these types of additional materials are also included in the concept of paper materials.

According to an embodiment in which the moisture permeable film is layered to the outer surface side of the second textile sheet 3 in a case where the disposable textile product is underpants, upon occurrence of incontinence during wearing the underpants, the moisture permeable film does not allow the passage of liquid, and therefore urine leakage to the outside can be prevented.

In the example illustrated in FIG. 1B, non-bonded region 8 is formed so that the space section 9 formed between the first textile sheet 2 and the textile material sheet 4, and the space section 9 formed between the textile material sheet 4 and the second textile sheet 3 are arranged in an opposing manner with the textile material sheet 4 interposed therebetween. The space section 9 is formed in this manner, as illustrated by the arrows of FIG. 22, the shortest path for water vapor to pass inside the multi-ply sheet 1b and move towards the outside of the composite textile sheet is open, the evaporation of moisture can be efficiently achieved, and the effect of improving the moisture transpiration property is significant.

FIG. 2 illustrates an embodiment in which the space section 9 formed between the first textile sheet 2 and the textile material sheet 4, and the space section 9 formed between the textile material sheet 4 and the second textile sheet 3 are not arranged in a mutually opposing manner, and are shifted from each other in the lateral direction. If the space sections 9 are formed in this mutually shifted manner, even in a case where the path for transporting water vapor through the inside of the multi-ply sheet 1b and towards the outside of the composite textile sheet is a short path (thick arrow in FIG. 2), the path is longer than the shortest path illustrated in the example described in FIG. 22, and therefore the time for which sweat or urine remains in the textile material sheet 4 is likely to be longer in comparison to that in the example of FIG. 22. Thus, sweat and urine may be absorbed more easily by the textile material sheet 4. Note that the adhesive may be applied and the space section 9 may be formed such that the space section 9, which is arranged in a mutually opposing manner and has the textile material sheet 4 interposed therebetween, and the space section 9, which is not arranged in a mutually opposing manner and has the textile material sheet 4 interposed therebetween, may coexist.

A nonwoven fabric can be used as the first textile sheet 2, and a two-layer or a three-layer spunbond nonwoven fabric can be used as this nonwoven fabric. In a case where the first textile sheet 2 is used at the skin surface side of an exterior sheet 11 of disposable underpants 10 (FIG. 3), a hydrophilic nonwoven fabric is preferably used as the first textile sheet 2. In a case where hydrophilicity is required for the composite textile sheet 1, a hydrophilic treatment such as the addition of a hydrophilic agent to the composite textile sheet 1 may be performed for example. The basis weight of the first textile sheet 2 is preferably, as one example, from 10 to 50 g/m², and from the perspective of manufacturing costs, the basis weight thereof is more preferably from 10 to 20 g/m², but is not limited to these ranges.

A nonwoven fabric can be used as the second textile sheet 3, and a two-layer or a three-layer spunbond nonwoven fabric can be used as this nonwoven fabric. In a case where the second textile sheet 3 is used at the non-skin surface side of the exterior sheet 11 of the disposable underpants 10, a water repellent nonwoven fabric is preferably used as the second textile sheet 3. A three-layer spunbond nonwoven fabric can be used as the water repellent nonwoven fabric, and a water repellent treatment in which a silicone-based, fluorine-based, paraffin metal-based, or alkyl chromic chloride-based water repellent agent is coated thereon is preferably performed. The basis weight of the water repellent nonwoven fabric is preferably, as one example, from 10 to 50 g/m², and from the perspective of manufacturing costs, the basis weight thereof is more preferably from 10 to 20 g/m², but is not limited to these ranges. In addition, the first textile sheet 2 and the second textile sheet 3 may be the same basis weight.

A paper material containing cellulose fibers can be used as the textile material sheet 4, and in this case, a paper material formed from a material using pulp paper or pulp as a principal raw material can be used. Pulp such as wood pulp, synthetic pulp, and waste paper pulp can be used as the raw material pulp. Additionally, the raw material pulp is not limited to natural fibers such as pulp, and regenerated fibers such as rayon can be used. The basis weight of the textile material sheet 4 is preferably, as one example, from 10 to 50 g/m², and is preferably smaller than the basis weight of the first textile sheet 2 and the basis weight of the second textile sheet 3. As an example, the basis weight of the textile material sheet 4 is preferably from 5% to 25% smaller than the basis weight of the first textile sheet 2. Likewise, the basis weight of the textile material sheet 4 is preferably from 5% to 25% smaller than the basis weight of the second textile sheet 3. However, the present embodiment does not exclude cases in which the basis weight of the textile material sheet 4 is greater than the basis weight of the first textile sheet 2.

Moreover, in a case where a paper material is used as the textile material sheet 4, the textile material sheet 4 is preferably subjected to embossing in order to impart softness. Furthermore, if the composite textile sheet 1 is used in the exterior sheet 11 of the disposable underpants 10, various printing may be applied in advance on this paper material to form a printed layer. The surface of this printed layer may be subjected to color proofing through varnishing and the addition of a binder. Examples of the binder include known materials such as PVA, CMC, EVA, acrylic, and lacquer. An ink subjected to a color proofing treatment can be also used.

As the moisture permeable film, moisture permeable films such as those that include a polyolefin-based resin and an inorganic filler, and those that include a polyethylene resin composition and an inorganic filler can be used. More specifically, a polyethylene-based microporous film can be used as the moisture permeable film, but the moisture permeable film is not limited thereto. In this case, a paper material may be used as the textile material sheet 4, which excels in transpiration performance and heat dissipation, and therefore heat within the body is transferred to outside the body through the textile material sheet 4 and the moisture permeable film. In a case where a composite textile sheet 1 including a moisture permeable film provided on the outer surface side of the second textile sheet 3 is used, for example, in the fabric of the gloves 310, 310a, the raincoat 311, and the underpants 10, 312, the composite textile sheet 1 excels in transpiration performance and heat dissipation as described above, and therefore gloves, raincoats, underpants, and sheets that do not cause stuffiness when used can be provided. In addition, design aspect can be improved by applying various printing to the textile material sheet 4 and moisture permeable film.

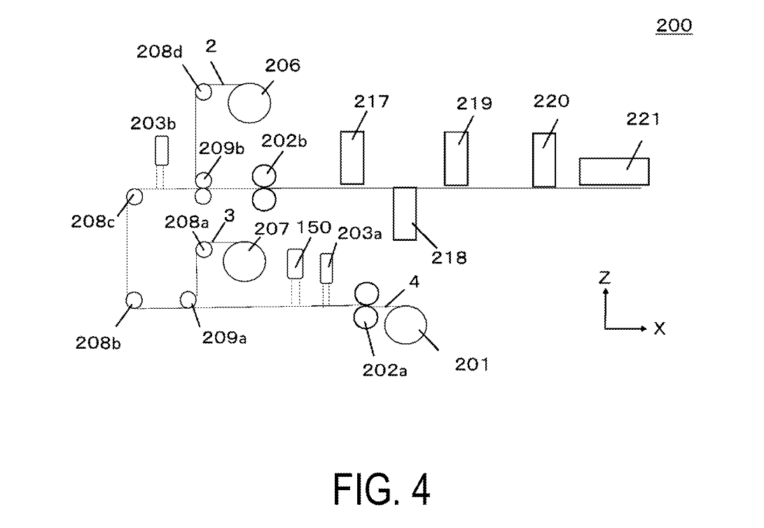

In the present embodiment, the space 9 present in the non-bonded region 8 is also a part of the multi-ply sheet 15. In addition, the first textile sheet 2, the second textile sheet 3, and the textile material sheet 4 of the approximately same areas are layered in the present embodiment. However, these sheets are not required to have the same area, and the areas may differ by a few % to around 10%. As described below, the textile material sheet 4 may be softened by pressing with embossing rollers 202a depicted in FIG. 4. Therefore, hereinafter, the treatment of softening by applying mechanical pressure is referred to as a mechanical softening treatment. In a case where the mechanical softening treatment is implemented, in some cases, the surface conditions may be changed or very small holes may be formed by this mechanical softening treatment, causing a change in the area. Therefore, in the present embodiment, a difference in the area from a few % to around 10% is allowed. As described above, the first textile sheet 2, the second textile sheet 3, and the textile material sheet 4 have nearly the same area in the composite textile sheet 1. In other words, the first textile sheet 2, the second textile sheet 3, and the textile material sheet 4 have the same shape in the composite textile sheet 1 and in the disposable underpants 10. Note that in the present embodiment, the term “same shape” is used where a difference in the shape due to manufacturing errors is allowed to some extent.

As described above, in the present embodiment, the textile material sheet 4 is subjected to a mechanical softening treatment through embossing, and through this mechanical softening treatment, the textile material sheet 4 can be imparted with flexibility that resembles flexibility achieved by hand-rubbing the textile material sheet 4. As a result, the entire composite textile sheet 1 exhibits softness, and becomes soft to the touch. Also, during embossing by the embossing rollers 202a, minute holes can be formed in the textile material sheet 4. In a case where minute holes are formed in this manner, during bonding the first and second textile sheets 2, 3 by an adhesive (a bonding step in the manufacturing process), the adhesive penetrates the holes, and as a result, the adhesion between the first and second textile sheets 2, 3 and the textile material sheet 4 is improved, and the bonding strength between the first and second textile sheets 2, 3 and the textile material sheet 4 is increased. Note that the holes formed through embossing are dependent on the embossing pattern, and can be various shapes such as round, square, hexagonal, and a break-off shape.

The amount of the adhesive 7 for bonding the first textile sheet 2 and the textile material sheet 4, and the amount of the adhesive 7 for bonding the second textile sheet 3 and the textile material sheet 4 can be determined as appropriate. However, a larger amount of the adhesive reduces the area of the non-bonded region 8 between the first textile sheet 2 and the textile material sheet 4, and the area of the non-bonded region 8 between the second textile sheet 3 and the textile material sheet 4. Thus, the area of the space section 9 in each of the non-bonded regions 8 is also reduced. As a result, the area of the moisture transpiration path, through which the space sections 9, 9 in each of the non-bonded regions 8, 8, the textile gap of the first textile sheet 2, the textile gap of the second textile sheet 3, and the textile gap of the textile material sheet 4 mutually communicate, is also reduced overall, resulting in a decrease in the moisture transpiration property and air permeability. In addition, the larger amount of the adhesive reduces the softness of the composite textile sheet 1 (the sheet becomes hard), and degrades the feel when worn in a case where the composite textile sheet 1 is used as the fabric for a disposable product. The bonding area between the first textile sheet 2 and the textile material sheet 4 and the bonding area between the second textile sheet 3 and the textile material sheet 4 are both preferably from 50% to 90%, and more preferably from 70% to 90% of the area of the first textile sheet 2 or the second textile sheet 3.

From the above-described perspective, the application amount of the adhesive when bonding 1 m² of the first textile sheet 2 and the textile material sheet 4, and the application amount of adhesive when bonding 1 m² of the second textile sheet 3 and the textile material sheet 4 are both preferably from 0.8 to 5.0 g/m². When the application amount is less than 0.8 g/m², the bonding strength between the first and second textile sheets 2,3 and the textile material sheet 4 is reduced, and peeling between each of the sheets easily occurs. When the application amount exceeds 5.0 g/m², the area of the moisture transpiration path becomes small, the moisture transpiration property and air permeability decrease, and the softness of the composite textile sheet 1 is lost. The adhesive application amount is more preferably from 1.0 to 3.5 g/m². Furthermore, in order to provide a composite textile sheet 1 with further improved softness, the upper limit value of the adhesive application amount is preferably set to 1.5 g/m².

Note that bonding between the first textile sheet 2 and the textile material sheet 4, and bonding between the second textile sheet 3 and the textile material sheet 4 can be performed through various bonding methods that are ordinarily used such as using an adhesive, ultrasonic welding, and heat sealing. When an adhesive is used, an adhesive such as a hot-melt adhesive and a solvent-based adhesive can be used. When bonding, the space sections 9 may be arranged so as to be mutually opposing, or the space sections 9 may be arranged so as to be mutually shifted, with the textile material sheet 4 interposed therebetween.

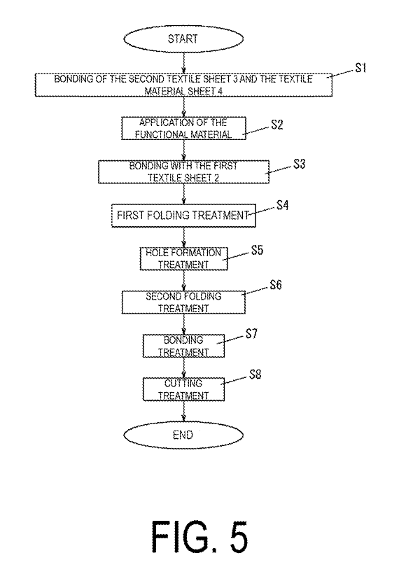

The method for manufacturing the composite textile sheet 1 of the present embodiment is described below using, as an example, a case of manufacturing the disposable underpants 10 that use the composite textile sheet 1. FIG. 4 is a schematic view for describing a manufacturing process 200 for the composite textile sheet 1, and FIG. 5 is a flowchart for describing the method for manufacturing the composite textile sheet 1. The layout of each of the devices in the manufacturing process 200 illustrated in FIG. 4 is merely an example, and the layout is not limited thereto. Note that here, a case where the composite textile sheet 1 is the multi-ply sheet 15 of FIG. 1B is described as an example.

### Step S1: Bonding of the Second Textile Sheet 3 and the Textile Material Sheet 4

The textile material sheet 4 wound on a sheet roll 201 is conveyed to the negative side in the X-direction of FIG. 4 (to the left in the horizontal direction), and is embossed by a pair of embossing rollers 202a and thereby subjected to a mechanical softening treatment. Note that below-described embossing rollers 202b are used in the manufacturing process 200, but the embossing rollers 202a and 202b may be the same embossing rollers, or may be embossing rollers that differ in aspects such as the embossing pattern, size, and material. A pattern (see FIG. 3) may be printed in advance onto the textile material sheet 4 wound on the sheet roll 201, and the above-described embossing may be performed on the textile material sheet 4 on which the pattern was printed.

The textile material sheet 4 that has passed through the embossing roller 202a is coated with an adhesive by an adhesive application device 203a. In the present embodiment, hot-melt adhesive is used as the adhesive, but the adhesive is not limited thereto.

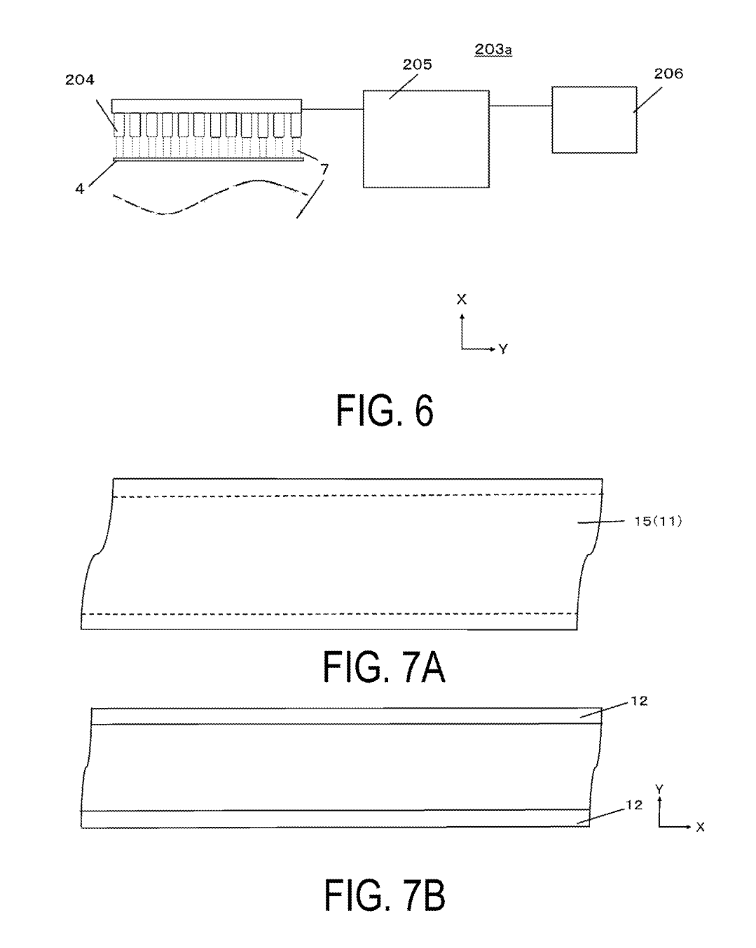

FIG. 6 is a schematic view illustrating the adhesive application device 203a. The adhesive application device 203a includes: a plurality of nozzles 204 configured to apply the adhesive 7 onto a first surface (bonding surface with the second textile sheet 3) of the textile material sheet 4; an accommodation section 205 configured to accommodate the adhesive 7 and including a heating unit configured to heat the adhesive 7 to a recommended temperature; and a controller 206 configured to control the heating temperature of the heating unit. FIG. 6 schematically illustrates a condition in which the adhesive 7 is applied to the textile material sheet 4. Note that in a case where a functional material described below is applied to a portion of the textile material sheet 4 where the adhesive 7 is not applied (outlined portion in the drawing), the adhesive 7 and the functional material are not mixed, or mixing thereof can be reduced. The amount of adhesive applied by the adhesive application device 203a is as described above.

### Step S2: Application of the Functional Material

The functional material is applied to the textile material sheet 4. Examples of the functional material include deodorants, insect repellents, fragrances, waterproofing agents, antifouling agents, and antibacterial agents. In the present embodiment, a case where a deodorant, a fragrance, and a softener are applied as functional materials is described, but the present invention is not limited thereto.

A functional material application device 150 has a nozzle, and is configured to apply (spray) a functional material onto the first surface of the textile material sheet 4. The functional material application device 150 may also be a device that is configured to apply a functional material onto a second surface (bonding surface with the first textile sheet 2) of the textile material sheet 4, and the device may be configured to apply a functional material onto a sheet other than the textile material sheet 4 as long as the sheet thereof is not contacted by the wearer. A plurality of functional material application devices 150 may be provided according to the number of functional materials. Alternatively, a plurality of functional materials may be mixed and then applied by the functional material application device 150 onto the textile material sheet 4.

As the deodorant, which is a functional material, catechin, epigallocatechin, gallocatechin, epicatechin gallate, epigallocatechin gallate, gallotannin, and ellagitannin, which are extracts from plants such as catechins and tannins; iron-ascorbic acid chelate compounds; hydroxides of zirconium;

hydroxides of lanthanoid; and salts of metals such as Zn, Cu, and Fe (for example, ZnSO₄) can be used. In the present embodiment, an alum (potassium alum) or a polyphenol is applied by the functional material application device 150. There are cases in which a liquid in which a metal is dissolved is used for the functional material such as alum, and therefore application to a portion that does not directly contact the skin (for example, a sheet other than on the skin surface side) is preferable. The textile material sheet 4 of the present embodiment is not at the skin surface side, and therefore the metal substance does not contact the wearer.

As the fragrance, which is a functional material, essential oils of fruits such as oranges, lemons, limes, and peaches; of flowers such as rose and lavender; and of mint and sandalwood (plants) can be used, and fragrances other than those mentioned above can also be used. This fragrance may be applied (sprayed) using the functional material application device 150. Note that fragrances may be selectively used according to gender, use by an adult or use by a child, and region.

As the softener, which is a functional material, a polyol (glycerin for example), which is a polyhydric alcohol and which softens the textile material sheet 4, can be used. In the present embodiment, the functional material is applied before bonding the second textile sheet 3 and the textile material sheet 4, but application after passing through the embossing rollers 202a is preferable. This is because when the functional material (glycerin for example) is applied before passage through the embossing rollers 202a, there is a concern that the textile material sheet 4 could easily tear, and the torn end of the textile material sheet 4 could adhere to the embossing rollers 202a, and thereby hinder the manufacturing of the composite textile sheet 1. The functional material may also be applied to the textile material sheet 4 or the second textile sheet 3 after bonding of the second textile sheet 3 and the textile material sheet 4. Furthermore, the functional material may be applied before the step of manufacturing the textile material sheet 4.

The second textile sheet 3 wound on a sheet roll 207 is conveyed to the negative side (downward) in the Z-direction by a conveyance roller 208a, and is bonded to the textile material sheet 4 onto which the adhesive 7 was applied, by a pressing roller 209a. In the present embodiment, the above-described bonding area between the second textile sheet 3 and the textile material sheet 4 is the area after passing the pressing roller 209a. Furthermore, the bonded second textile sheet 3 and textile material sheet 4 are conveyed to the positive side (upward) in the Z-direction by conveyance rollers 208b, 208c.

Step S3: Bonding with the First Textile Sheet 2

The second surface of the textile material sheet 4 is coated with the adhesive 7 by an adhesive application device 203b to bond the bonded second textile sheet 3 and textile material sheet 4 with the first textile sheet 2. In the present embodiment, a hot-melt adhesive is used as the adhesive 7, but the adhesive is not limited thereto. Note that the adhesive 7 is heated to a prescribed temperature (60° C. to 150° C. for example) by the second adhesive application device 203b, and the application amount is as described above.

The first textile sheet 2 wound on a sheet roll 206 is conveyed to the negative side (downward) in the Z-direction by a conveyance roller 208d. A pair of pressing rollers 209b press and bond the first textile sheet 2 and the bonded body of the bonded second textile sheet 3 and textile material sheet 4, and thereby the multi-ply sheet 15 (composite textile sheet 1) is manufactured. In the present embodiment, the above-described bonding area between the first textile sheet 2 and the textile material sheet 4 is the area after passage through the pair of pressing rollers 209b.

The multi-ply sheet 15 is formed by laminating in order from the positive side (top side) in the Z-direction, the first textile sheet 2, the textile material sheet 4, and the second textile sheet 3. When the first textile sheet 2, the textile material sheet 4, and the second textile sheet 3 are layered by the pair of pressing rollers 209b, the first textile sheet 2, the textile material sheet 4, and the second textile sheet 3 may have the same area and the same shape. Alternatively, after a cutting step (cutting by a below-described cutting device 221 for example), the first textile sheet 2, the textile material sheet 4, and the second textile sheet 3 may have the same area and the same shape. In the present embodiment, the textile material sheet 4 is positioned between the first textile sheet 2 and the second textile sheet 3, and because the textile material sheet 4 is embossed by the pair of embossing rollers 202a, the dimension in the sheet width direction of each of the first textile sheet 2 and the second textile sheet 3 set in the sheet rolls may be larger than the dimension in the width direction of the textile material sheet 4. The multi-ply sheet 15 is embossed, or in other words, is subjected to a mechanical softening treatment by a pair of embossing rollers 202b. Note that embossing of the multi-ply sheet 15 by the embossing rollers 202b may be omitted.

A nonwoven fabric can be used as the first textile sheet 2 and the second textile sheet 3, and the nonwoven fabric is a material that does not easily wrinkle. On the other hand, a paper material containing cellulose fibers can be used as the textile material sheet 4, but the paper material is a material that easily wrinkles. Here, the multi-ply sheet 15 (composite textile sheet 1) may be formed after subjecting the textile material sheet 4 to deep embossing by the embossing rollers 202a such that a plurality of minute holes are formed in the textile material sheet 4, then wrinkles may not be easily formed in the multi-ply sheet 15 (composite textile sheet 1). Furthermore, the multi-ply sheet 15 (composite textile sheet 1) may be embossed by the embossing rollers 202b, and wrinkles may be formed less likely. Therefore, in a case where the composite textile sheet 1 of the present embodiment is used as a fabric for clothing, ironing to remove wrinkles is not necessary. The same effect can be achieved even for cases in which the moisture permeable film is used in place of the second textile sheet 3.

The method for manufacturing the composite textile sheet 1 of the present embodiment is as described above. Next, a method for manufacturing the disposable underpants 10 using the composite textile sheet 1 of the present embodiment is described using FIGS. 4 and 5. This process for manufacturing the disposable underpants 10 begins from a step S4 (first folding treatment) illustrated in FIG. 5.

### Step S4: First Folding Treatment

The multi-ply sheet 15 is conveyed to the positive side (right direction) in the X-direction in FIG. 4, and both end edges in the width direction of the sheet are folded by a first folding device 217 to form a torso fitting section 12 (see FIG. 3) for the disposable underpants 10. FIG. 7 is a schematic view for describing the first folding treatment. As illustrated in FIG. 7A, the multi-ply sheet 15 that is to be the exterior sheet 11 is formed into the shape illustrated in FIG. 7B by valley-folding the edge portions of both ends in the sheet width direction along the dotted line portions illustrated in FIG. 7A. This folded portion is to be the torso fitting section 12 of the disposable underpants 10. The first folding device 217 is a known device having a folding plate for folding the multi-ply sheet 15, and a pressing part for pressing the folded multi-ply sheet 15. In addition, this folded portion is bonded through various bonding methods such as bonding by heat sealing or a hot-melt adhesive, and ultrasonic welding.

### Step S5: Hole Formation Treatment

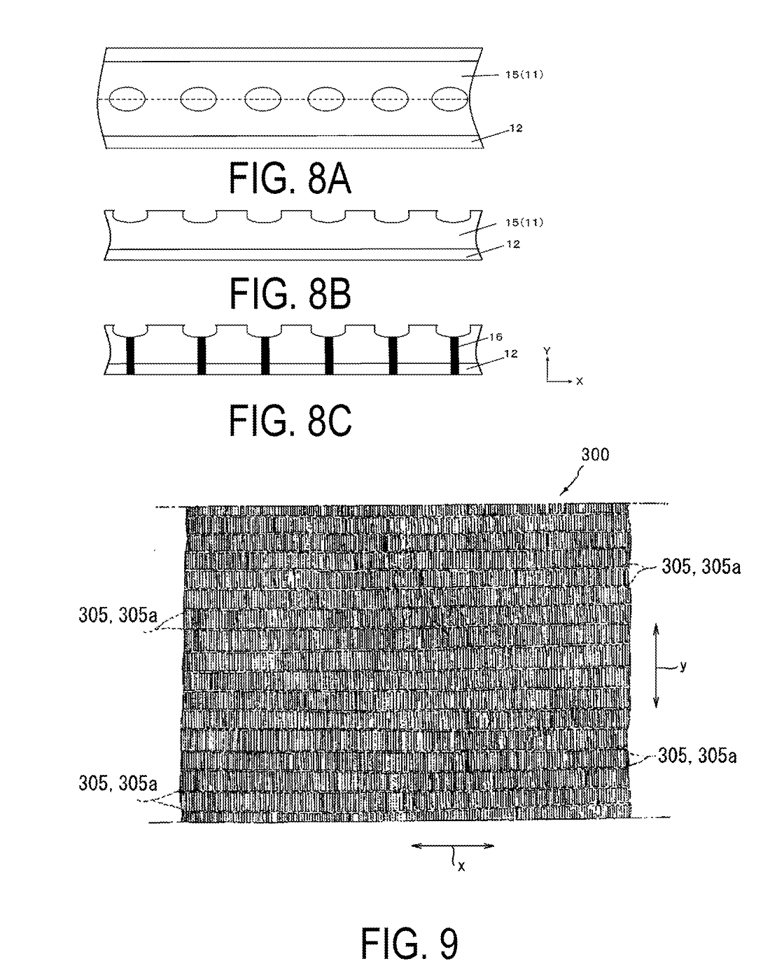

The multi-ply sheet 15 that has been subjected to the first folding treatment by the first folding device 217 is conveyed to the positive side (right direction) in the X-direction, and holes are formed by a hole formation device 218 to form the leg parts of the disposable underpants 10. A die cut roller can be used, for example, as the hole formation device 218, but the hole formation device 218 is not limited thereto. FIG. 8 is a drawing for describing processing from the hole formation treatment to the bonding treatment. FIG. 8A illustrates the multi-ply sheet 15 in which holes have been formed, and in this example, an aspect is illustrated in which elliptically shaped holes are provided passing through a center line of the multi-ply sheet 15. Note that the hole formation treatment may also be performed before the first folding treatment. In addition, the shape of the holes is not limited to an elliptical shape.

### Step S6: Second Folding Treatment

The second folding treatment, to prepare for the bonding treatment of step S7, is implemented to mountain-fold the multi-ply sheet 15 at the center in the sheet width direction along the center dotted line of FIG. 8A using a second folding device 219. The second folding device 219 includes: an arm member for lifting the multi-ply sheet 15 at the center dotted line in order to perform mountain folding; and a drive unit for driving the arm member to set the mountain-folded multi-ply sheet 15 on a conveyance member (not illustrated). FIG. 8B illustrates the multi-ply sheet 15 folded in the sheet width direction along the center dotted line of FIG. 8A. In other words, the multi-ply sheet 15 is in a mountain-folded state.

As the second folding treatment, in place of mountain-folding the multi-ply sheet 15 at the center dotted line, the front and back sides of the multi-ply sheet 15 may be inverted by an inverting mechanism (not illustrated), and the central portion of the inverted multi-ply sheet 15 may be valley-folded.

### Step S7: Bonding Treatment

The multi-ply sheet 15 that was mountain-folded at the center in the sheet width direction is bonded along the sheet width direction by a bonding device 220 to form the disposable underpants 10. As the bonding device 220, various bonding devices such as an ultrasonic welding device, a heat sealing device, and a hot-melt adhesive application device can be used. FIG. 8C illustrates a multi-ply sheet 15 that has been bonded by the bonding device 220, and a plurality of bonded sections 16 are formed in the multi-ply sheet 15 along the sheet width direction. FIG. 8C illustrates a state in which the first textile sheet, which is to be the skin surface side, is an exposed surface (outer surface), and the bonded sections 16 are also exposed. After the next cutting step (step S8), the front and back sides of this cut body are inverted to position the first textile sheet 2 at the non-exposed surface (inner surface side), and position the bonded sections 16 at the inner surface side as well. Therefore, in the present embodiment, when a user is wearing the disposable underpants 10, the bonded sections 16 are formed at the skin surface side, and therefore the bonded sections 16 are not visible, and the design aspect of the disposable underpants 10 can be improved. In particular, this may mitigate user's reluctance in wearing a disposable diaper for an issue such as minor incontinence.

### Step S8: Cutting Treatment

The multi-ply sheet 15 in which the bonded sections 16 have been formed is cut by a cutting device 221 including a cutter to form individual disposable underpants 10. That is, the cutting device 221 cuts the center part of the bonded sections 16 along the width direction of the multi-ply sheet 15. Thus, single disposable underpants 10 like that illustrated in FIG. 3 is manufactured. Note that the bonding treatment and cutting can be performed simultaneously, and in this case, for example, a method in which cutting is implemented at the same time as bonding using a heat welding blade can be used.

The disposable underpants 10 that is manufactured as described above includes the exterior sheet 11, and the torso fitting section 12 that fits around the waist of the user. In the exterior sheet 11, the first textile sheet 2, the textile material sheet 4, and the second textile sheet 3 are layered in this order from the side that is in contact with the skin of the user.

The torso fitting section 12 is formed by bending the exterior sheet 11. The composite textile sheet 1 does not include an elastic member (for example, an elastic member such as polyurethane), but an elastic member may be used in the torso fitting section 12. In a case where an elastic member is used in the torso fitting section 12, the disposable underpants 10 does not easily shift downward when worn. Note that the torso fitting section 12 may also be formed without bending the exterior sheet 11.

With the disposable underpants 10 formed in this manner, an absorbent member 14 can be attached as illustrated in FIG. 3. Note that while not particularly illustrated, adhesive tape, for example, may be provided (in two places for example) at the attachment surface of the absorbent member 14, the attachment surface being the side opposite the skin surface side, allowing attaching or detaching the absorbent member 14 to or from the disposable underpants 10. Instead of configuring the absorbent member 14 in an attachable/detachable manner, the absorbent member 14 may be attached in a fixed manner to the disposable underpants 10. This absorbent member 14 contains crushed pulp and a super absorbent polymer, which is a particle shaped super absorbent resin, and absorbs body fluids such as urine, sweat, and blood. Even in a case where a body fluid such as urine or sweat leaks from the absorbent member 14, as described above, the composite textile sheet 1 excels in transpiration performance, and therefore can release water vapor outward with good efficiency, the wearing feeling of the user is good, and because liquid is absorbed, there is no concern about soiling pants or a skirt.

The disposable underpants 10 can withstand washing multiple times, and therefore can be used for a certain period of time as long as the absorbent member 14 (FIG. 3) is replaced.

### Second Embodiment

Next, a composite textile sheet according to a second embodiment of the present invention is described. In the present embodiment, an elastic member 305 is provided between a first textile sheet 302 and a textile material sheet 304, and stretchability is imparted to a multi-ply sheet 315 by the elastic member 305.

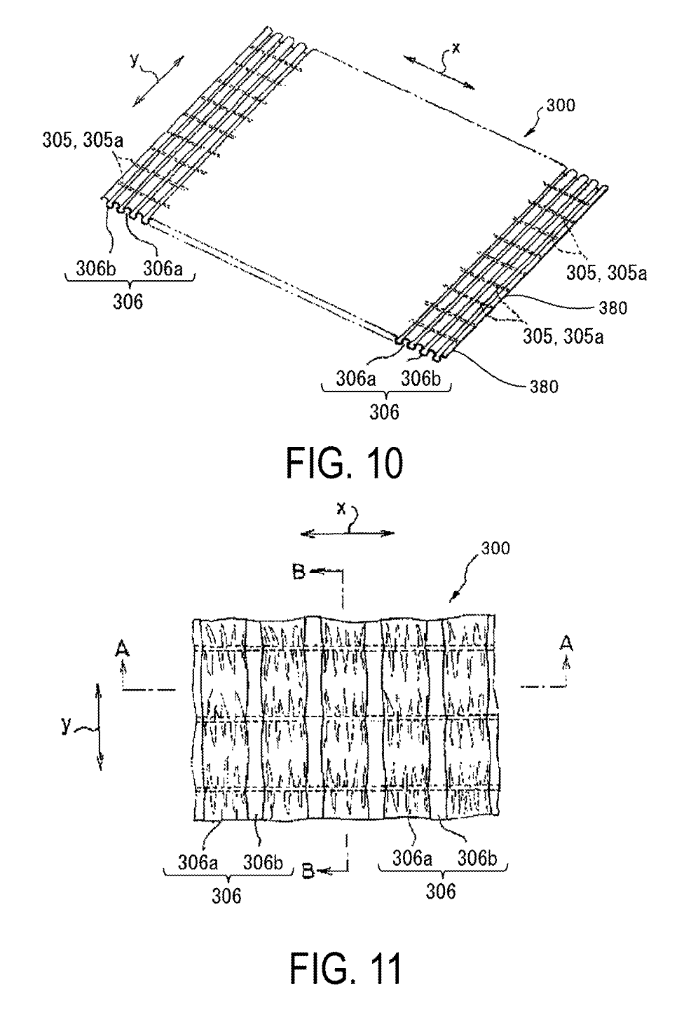

FIG. 9 is a plan view illustrating a composite textile sheet 300 according to the present embodiment, FIG. 10 is a view for describing a shirring portion 306 of the composite textile sheet 300, and FIG. 11 is an enlarged view of the composite textile sheet 300. In FIG. 9, the composite textile sheet 300 extends in the x-direction, which is the length direction. The elastic member 305 is provided inside the composite textile sheet 300, numerous uneven surfaces are formed by numerous elastic members 305, and as illustrated in FIG. 10, numerous shirring portions 306 are repeatedly formed along the x-direction by these numerous uneven surfaces. Furthermore, rows 380 of valleys and peaks including a repetition of valley portions 306b and peak portions 306a are formed between an elastic member 305 and another elastic member 305, and a shirring formation section, which is an aggregate of shirring portions 306, is formed by a plurality of rows 380 of valleys and peaks. As is clear from FIGS. 9 and 10, the elastic member 305 is provided along the x-direction, and imparts an elastic force in the x-direction to the composite textile sheet 300. A plurality of this type of elastic member 305 are provided at prescribed intervals in the width direction (y-direction).

The elastic member 305 is linear and cylindrical, or in other words, the cross-sectional shape is circular. The elastic member 305 is formed from, for example, a natural rubber or a synthetic rubber based on urethane, silicone, butadiene, or styrene-butadiene. In addition, the elastic member 305 may be a combination of any of the materials of these synthetic rubbers or natural rubbers, as appropriate. Note that the elastic member 305 is not limited to a cylindrical shape, and may be a triangular prism shape, a quadrangular prism shape, or another polygonal prism or elliptical prism shape. In addition, the elastic member 305 may be one which is obtained by bundling or twisting together a plurality of linear members. In the present embodiment, a linear elastic body 305a having stretchability is used as the elastic member 305, and as this linear elastic body 305a, a natural rubber or synthetic rubber based on urethane and silicone can be used. Note that an elastic member having a lattice-like shape can also be used, and in this case, the above-described numerous shirring portions 306 can be formed with a single lattice-like shape. In addition, a stretchable film may be used in place of the numerous elastic members 305. As the stretchable film, films such as a urethane film, a silicone film, and an elastomer film can be used.

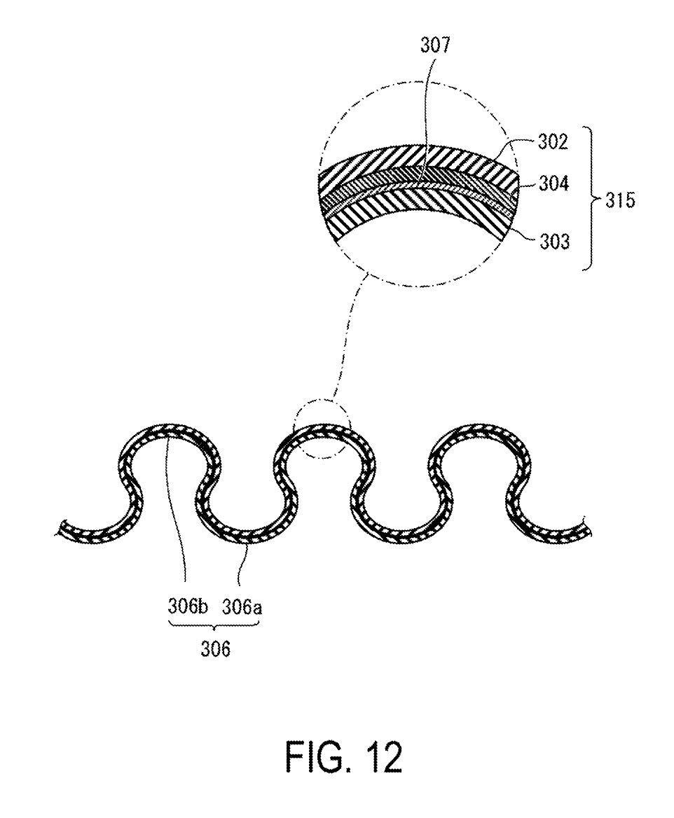

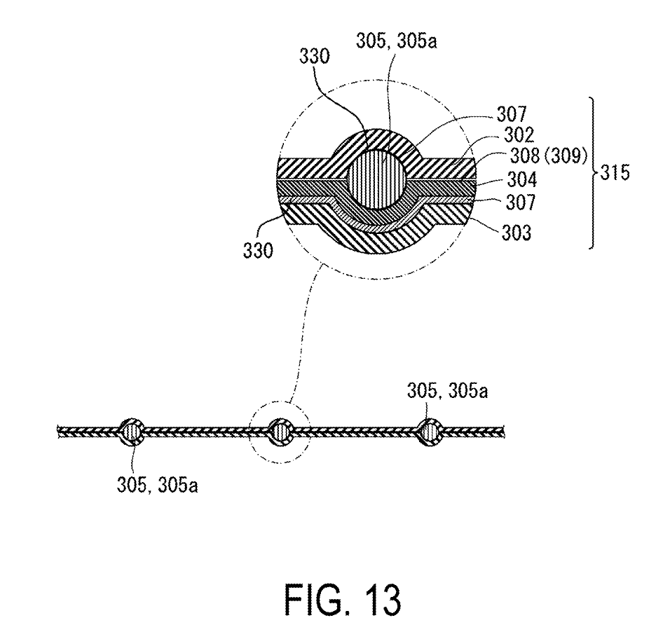

FIG. 12 is a cross-sectional view along the line A-A of FIG. 11, and FIG. 13 is a cross-sectional view along the line B-B of FIG. 11. As illustrated in FIGS. 12 and 13, the composite textile sheet 300 is configured from a multi-ply sheet 315 including: a first textile sheet 302, which is a sheet having air permeability, a second textile sheet 303, which likewise is a sheet having air permeability, and a textile material sheet 304 which is interposed between the first and second textile sheets 302 and 303 and has liquid diffusibility, the multi-ply sheet being formed by laminating the first and second textile sheets 302, 303 and the textile material sheet 304. The first and second textile sheets 302, 303 constitute fiber layers having air permeability, and the textile material sheet 304 constitutes a fiber layer having liquid diffusibility. In this manner, the multi-ply sheet 315 is configured from three layers.

The composite textile sheet 300 is not limited to a composite textile sheet having a three layer structure formed by laminating the first and second textile sheets 302, 303 and the textile material sheet 304, and as illustrated in FIG. 24, the composite textile sheet 300 may have a multi-ply sheet 345, having a two layer structure formed by laminating the first textile sheet 302 and the textile material sheet 304 with an elastic member 305 arranged between the first textile sheet 302 and the textile material sheet 304.

Moreover, similar to the composite textile sheet 1 of the first embodiment, a moisture permeable film may be layered to the composite textile sheet 300 at a position directly facing the textile material sheet 304. However, from the viewpoint of ensuring the moisture transpiration property by the composite textile sheet 1, the moisture permeable film is preferably layered to a position that is not directly facing the first textile sheet 302, which is the textile sheet that is slated to be positioned at the skin surface side.

Furthermore, various modifications may be made to the configuration of the composite textile sheet 300, and these may be used in the composite textile sheet 301a and composite textile sheet 301c described below. In the present embodiment, as described below, in cases where the composite textile sheet 300 is applied in the gloves 310, 310a, the raincoat 311, the underpants 10, 312, and sheets (not illustrated), the first textile sheet 302 is at the side that contacts the skin of the user (skin surface side), and the second textile sheet 303 is at the outer side (non-skin surface side).

In both cases where the composite textile sheet 300 of the present embodiment is a two-layer configuration and a three-layer configuration, as illustrated in FIGS. 13 and 24, the composite textile sheet 300 is such that the first textile sheet 302 and the textile material sheet 304 are bonded by an adhesive 307 that is applied to the circumferential surface of the elastic member 305, and bonded regions 330 are formed at the sections coated by the adhesive 307. On the other hand, the adhesive 307 is not present in the plane of mutual contact between the first textile sheet 302 and the textile material sheet 304 at a portion where the elastic member 305 is not present, and therefore non-bonded region 308 where the first textile sheet 302 and the textile material sheet 304 are not bonded is formed, and space section 309 is formed in the non-bonded region 308. In this manner, bonding between the first textile sheet 302 and the textile material sheet 304 becomes partial bonding, with bonding occurring at the arrangement location of the elastic member 5. Note that partial bonding may be performed even in a portion where the elastic member 305 is not present. In a case where the composite textile sheet 300 is a three-layer configuration as presented by the multi-ply sheet 315, the textile material sheet 304 and the second textile sheet 303 are in mutual contact as illustrated in FIG. 13. At this time, the plane of mutual contact between the textile material sheet 304 and the second textile sheet 303 is partially bonded by the adhesive 307, the bonded region 330 and the non-bonded region 308 are formed, and the space section 309 is formed in the non-bonded region 308. The non-bonded region 308 and the space section 309 that are formed between the textile material sheet 304 and the second textile sheet 303 are omitted from the illustration of FIG. 13.

In the composite textile sheet 300 configured as described above, the moisture transpiration path is formed through which the space section 309 formed in the non-bonded region 308 in the plane of mutual contact between the first textile sheet 302 and the textile material sheet 3044, the space section 309 formed in the non-bonded region 308 in the plane of mutual contact between the second textile sheet 3033 and the textile material sheet 304, the textile gap of the first textile sheet 302, the textile gap of the second textile sheet 303, and the textile gap of the textile material sheet 304 mutually communicate.

The above-described moisture transpiration path is formed in the composite textile sheet 300 of the present embodiment, and therefore the composite textile sheet 300 can exhibit an excellent moisture transpiration property through the action of these moisture transpiration path. In addition, forming the moisture transpiration path also exhibits improvement in the heat dissipation and moisture permeability of the composite textile sheet 300.

As illustrated in FIGS. 10, 11 and 12, numerous shirring portions 306 are formed by continuously forming peak portions 306a and valley portions 306b. As a method for forming the shirring portions 306 including the peak portions 306a and the valley portions 306b, the elastic member 305 is arranged inside the composite textile sheet 300 as indicated hereinabove. As described above, a linear elastic body 305a having stretchability is used as the elastic member 305, and polyurethane, for example, is used as this linear elastic body 305a.

As illustrated in FIGS. 9 and 10, the linear elastic body 305a is arranged such that the extension direction of a line thereof is the same direction as the longitudinal direction (x-direction in FIGS. 9 and 10), and numerous linear elastic bodies 305a are arranged parallel to each other at predetermined intervals. Thus, numerous linear elastic bodies 305a are arranged at intervals in the y-direction, and rows of linear elastic bodies are thus formed. The intervals at which the linear elastic bodies 305a are provided in the y-direction may be nearly uniform, or the linear elastic bodies 305a may be arranged at different intervals. In addition, the elastic forces of the linear elastic body 305a may be the same for all of the linear elastic bodies 305a, or all or some may be different. In either case, in a case where the composite textile sheet 300 is used as disposable underpants 312, the linear elastic bodies 305a are favorably arranged so that the elastic force of a torso fitting section 313 (see FIG. 20) is larger compared to the elastic force of other portions.

As indicated hereinabove, the linear elastic body 305a is provided between the first textile sheet 302 and the textile material sheet 304. Numerous shirring portions 306 are formed in the x-direction of FIGS. 9 and 10 to form a row 380 of valleys and peaks extending in the x-direction, and numerous rows of these type of rows 380 of valleys and peaks are formed in the y-direction to form a shirring formation section as a whole. The number of the linear elastic bodies 305a per unit area can be set as appropriate, but in a case where the number of the linear elastic bodies 305a is increased and the interval between the linear elastic bodies 305a is reduced, the peak portions 306a and the valley portions 306b in the shirring portion 306 formed at different positions in one shirring row extending in the x-direction can be formed to have a uniform shape and this shape can be maintained. Thus, the shape of the shirring portion 306 is prevented from collapsing, the shape of the shirring row is stable, and the softness, moisture transpiration property, heat dissipation ability, and moisture permeability of the composite textile sheet 300 are improved. From these viewpoints, the configuration above is preferred. From this standpoint, the interval between the shirring portions 306, that is, the pitch interval between the peak portions 306a, is preferably from 2.00 mm to 7.00 mm, and more preferably from 3.00 mm to 6.25 mm. By reducing the pitch interval between the mutual peak portions 306a, finely-shaped shirring can be formed, thereby improving the external appearance. Further, since an area of contact with the skin per one shirring decreases, contact feel with the skin is improved, and since the surface area increases, the ability to absorb sweat and other body fluids is enhanced. Meanwhile, by increasing the pitch interval between the peak portions 306a, the elastic force of the elastic body 305a can be suitably suppressed, and manufacturing costs can be reduced.

The multi-ply sheet 315 is long in lengthwise, and therefore the sheet is cut to obtain a predetermined length dimension in the longitudinal direction (x-direction in FIGS. 1 and 2) of the multi-ply sheet 315. In this cutting, the first and second textile sheets 302 and 303, the textile material sheet 304 and the elastic member 305 are cut. By cutting the elastic member 305, the tensile force applied to the elastic member 305 in the stretched state is released, and the elastic member 305 is contracted by the restoring force. Due to the contraction stress that occurs at this time, the multi-ply sheet 315 receives force in a direction that reduces the length, and therefore an uneven surface is formed in the multi-ply sheet 315. Thus, the shirring portions 306 are formed. In this manner, due to the restoring force of the elastic member 305, the multi-ply sheet 315 is in a non-stretched state, numerous shirring portions 306 extending in a direction (y-direction) orthogonal to the length direction (x-direction) of the multi-ply sheet 315 in this non-stretched state are formed. And the rows of shirring portions in the multi-ply sheet 315 form a pattern, and a composite textile sheet 300 having numerous shirring portions 306 is manufactured. Note that the composite textile sheet 300 may also be changed from a stretched state to a contracted state by reducing the conveyance speed of a conveyance device (conveyance roller) (not illustrated) that conveys the composite textile sheet 300 before cutting.

Elastic force is imparted to the multi-ply sheet 315 by the elastic member 5 disposed inside the multi-ply sheet 315. Therefore, when the composite textile sheet 300 is stretched in the x-direction of FIGS. 9 and 10, the elastic member 305 extends, causing the composite textile sheet 300 to also extend and expand. In addition, when this state is released, the elastic member 305 contracts due to the restoring force thereof, and as a result, the composite textile sheet 300 also returns to its original state. The composite textile sheet 300 has stretchability in this manner, and when the composite textile sheet 300 is used as disposable clothing, the disposable clothing excels in the fit feeling on the body. Furthermore, for the composite textile sheet 300, the dimension as a disposable article of clothing is determined by the dimension when contracted by the restoring force of the elastic member 305, and therefore the surface area per unit volume can be enlarged.

As specific examples of disposable textile products that are manufactured by appropriately using the composite textile sheet 1 presented in the first embodiment and/or the composite textile sheet 300 presented in the second embodiment as fabric, gloves, a raincoat, underpants, and sheets are described below as third, fourth, fifth, and sixth embodiments respectively. Note that for convenience of description, the same reference signs as those presented in the second embodiment are applied in the third to sixth embodiments to configurations that are the same as those of the second embodiment.

### Third Embodiment: Structure of the Glove 310

An example of the glove 310 that uses a composite textile sheet as the disposable textile product illustrated in FIGS. 14A and 14B is presented. The glove 310 is formed using a composite textile sheet 301a and a composite textile sheet 301b. As illustrated in FIGS. 14A and 14B, the glove 310 has a fingertip section that is separated into five sections, and for example, the composite textile sheet 301a is positioned at the back of the hand side, the composite textile sheet 301b is positioned at the palm side, and these sheets are bonded to form the glove 310. For bonding, a method such as ultrasonic welding and heat sealing is used. Note that in FIGS. 14A and 14B, for convenience of the description, only one of a pair of left and right gloves is illustrated (in the example of FIG. 14, a right handed glove is primarily assumed), and the other is omitted. The other glove may be configured so as to have the same layered structure as the glove that is illustrated.

In the glove 310, the composite textile sheet of the second embodiment is used as the composite textile sheet 301a, and the composite textile sheet 301a is configured by laminating the first textile sheet 302, the elastic member 305, the textile material sheet 304, and the second textile sheet 303 in this order from the side contacting the back of the hand. The composite textile sheet 301a is not limited to this example, and in place of the second textile sheet 303, a film (a moisture permeable film for example) may be used. When the elastic member 305 is provided at the back of the hand side, the glove 310 expands and contracts according to the hand of the wearer, and can fit to the hand of the wearer. Therefore, there is no slack between the glove 310 and the hand, and the glove 310 does not slip and fall off. Note that the elastic member 305 is arranged to transect the palm between the thumb and the little finger (lateral direction in the drawing), but may also be arranged to transect between the wrist and the fingertips (longitudinal direction in the drawing).

The composite textile sheet of the first embodiment is used as composite textile sheet 301b, and the composite textile sheet 301b is configured in the same manner as the composite textile sheet of FIG. 1B. The composite textile sheet 301b is configured by laminating the first textile sheet 302, the textile material sheet 304, and the second textile sheet 303 in this order from the side contacting the palm. The composite textile sheet 301b is not limited to this example, and in place of the second textile sheet 303, a film (a moisture permeable film for example) may be used. Furthermore, the composite textile sheet of the second embodiment may be used as the composite textile sheet 301b by providing the elastic member 305 between the first textile sheet 302 and the textile material sheet 304, or between the textile material sheet 304 and the second textile sheet 303. Moreover, the composite textile sheet 301a and the composite textile sheet 301b can have the same configuration. In this case, as described below, a universal glove 310a, for which the pair of gloves can be used on a right and left hand interchangeably, can be easily manufactured.

With the glove 310, the first textile sheet 302 contacts both the back of the hand and the palm, and therefore the glove 310 provides a soft texture when worn, and excels in air permeability. The textile material sheet 304 is bonded to the first textile sheet 302, and therefore when sweat is present at the back of the hand and the palm, the sweat is adsorbed by the textile material sheet 304. Furthermore, as illustrated in FIG. 13, the bonded region 330 and the non-bonded region 308 having a space section 309 are formed in each of the plane of mutual contact between the first textile sheet 302 and the textile material sheet 304, and the plane of mutual contact between the textile material sheet 304 and the second textile sheet 303 (the non-bonded region 308 in the plane of mutual contact between the textile material sheet 304 and the second textile sheet 303 is omitted from the illustration of FIG. 13), and moisture transpiration path is formed, through which each of the space sections 309, 309 in each of the non-bonded regions 308, 308, the textile gap of the first textile sheet 302, the textile gap of the second textile sheet 303, and the textile gap of the textile material sheet 304 mutually communicate, and therefore sweat is efficiently transpired and released to the outside of the glove without remaining in the fiber layer. In this manner, compared to conventional gloves (vinyl gloves for example), the glove 310 can be comfortably used without a feeling of discomfort such as stuffiness and stickiness during use of the glove.

FIG. 15 illustrates the universal glove 310a for which the pair of gloves can be used on the right and the left hand interchangeably, and similar to the glove 310, the composite textile sheet 301a is arranged on one side, the composite textile sheet 301b is arranged on the other side, and these sheets are bonded to form the glove 310a. In the present embodiment, as illustrated in FIG. 15, the fingertip section is divided into three, but the glove 310a may also be a type for which the fingertip section is divided into two. In addition to left/right interchangeability, the universal glove 310a of the present embodiment is also interchangeable with respect to the front and back (back of the hand side and palm side). The composite textile sheet 301a and the composite textile sheet 301b have the same multi-layered structure as the composite textile sheet 301a and the composite textile sheet 301b of the above-described glove 310 (FIG. 14). If the composite textile sheet 301a side is used as the back of the hand side, the glove will fit to the user's hand due to the stretching and contraction of the elastic member 305. In addition, the elastic member 305 is not present on the palm side, thereby facilitating easy grasp of an object. Thus, the glove is suited as a work glove for assembly and other work. On the other hand, when touching a hot object (the handle of a kettle for example), wearing the glove with the composite textile sheet 301a side, which has the elastic member 5, on the palm side of the hand, allows a contact with the hot object through shirring portions 306 that are formed by the elastic member 305 and reduces the contact area between the hand and the handle, or delay the heat transmission, suppressing sensation of heat.

The gloves 310, 310a can be used in various applications such as for protection against cold, for medical care, for operations (assembly, adjustments, sweeping, cleaning), and for sports. Note that when the gloves 310, 310a are used for medical care, a melt-blown nonwoven fabric that is formed from ultrafine fibers having a fiber diameter in a range from 2 to 20 microns, and that excels in filtering performance is preferably used. In this case, the melt-blown nonwoven fabric layer may be layered to the multi-ply sheet 315, or a melt-blown nonwoven fabric may be used for at least one of the first and second textile sheets 302 and 303. Note that a mitten shape can also be adopted as the shape of the gloves.

### Manufacturing the Glove 310

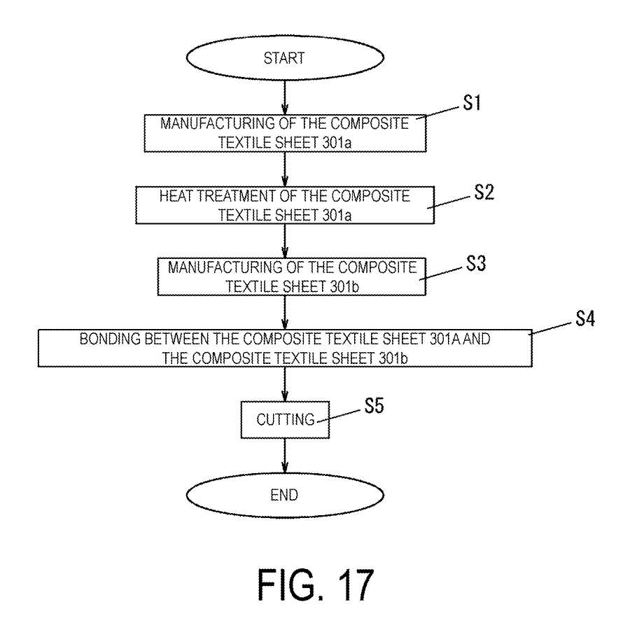

FIG. 16 is a schematic view illustrating a manufacturing process 400 for the glove 310, and FIG. 17 is a flowchart illustrating a method for manufacturing the glove 310. The layout of each of the devices in the manufacturing process 400 illustrated in FIG. 16 is merely an example, and the layout is not limited thereto. Note that here, a method for manufacturing the glove 310 is described, but the method for manufacturing the universal glove 310a and a mitten is the same.

### Step S1: Manufacturing the Composite Textile Sheet 301a

The textile material sheet 304 wound on a sheet roll 404a is conveyed in the X-direction, and is embossed by a pair of embossing rollers 410a, or in other words, is subjected to a mechanical softening treatment. A pattern is printed in advance onto the back surface (surface opposite to the second textile sheet 303) of the textile material sheet 304 that is wound onto the sheet roll 404a, and the textile material sheet 304 on which the pattern was printed is embossed.

The textile material sheet 304 that has passed through the embossing rollers 410a is coated with an adhesive 307 by an adhesive application device 411 to be bonded with the first textile sheet 302. In the present embodiment, hot-melt adhesive 307 can be used as the adhesive, but the adhesive is not limited thereto. The adhesive application device 411 has a plurality of nozzles, and sprays the hot-melt adhesive in a spray form. The adhesive 307 is heated to a prescribed temperature (from 60° C. to 150° C. for example) by the adhesive application device 411, and the hot-melt adhesive is applied at an amount from 0.8 g/m² to 2.0 g/m².

The first textile sheet 302 wound on a sheet roll 402a is conveyed to the negative side (downward) in the Z-direction by a conveyance roller 412a, and is bonded by pressing rollers 413a with the textile material sheet 304 onto which the adhesive 307 was applied.

The elastic member 305 that is wound onto an elastic roll 405 is coated with the adhesive 307 by the adhesive application device 411. In the present embodiment, a hot-melt adhesive can be used as the adhesive 307 that is coated onto the circumferential surface of the elastic member 305, but the adhesive 307 is not limited thereto. Moreover, the hot-melt adhesive that is used in the present embodiment may be the same in each step, or may be different (for example, adhesives with different viscosities). The adhesive 307 is heated to a prescribed temperature (60° C. to 150° C. for example) by the adhesive application device 411. A plurality of elastic rolls 105 is arranged according to the number of elastic members 5 to be used.

The second textile sheet 303 wound on a sheet roll 403a is conveyed to the positive side (upward) in the Z-direction by a conveyance roller 412b. Meanwhile, the first textile sheet 302 and textile material sheet 304 that were bonded as described above are conveyed to the negative side (downward) in the Z-direction. A pair of pressing rollers 413b presses and bonds the second textile sheet 303 and the bonded body of the first textile sheet 302 and the textile material sheet 304, with the elastic member 305, on which the adhesive 307 was applied, interposed therebetween. Thus, the composite textile sheet 301a is manufactured. The composite textile sheet 301a is formed as a multi-ply sheet that is obtained by laminating the first textile sheet 302, the textile material sheet 304, the elastic member 305, and the second textile sheet 303 in this order from the positive side in the Z-direction.

### Step S2: Heat Treatment of the Composite Textile Sheet 301a

As described above, the elastic member 305 is disposed inside the composite textile sheet 301a, and thereby imparting an elastic force to the composite textile sheet 301a. The surface area of the composite textile sheet 301a can be increased from around 1.5 times to around 5 times by selecting the elastic force of the elastic member 305. For example, in a case where a dimension of 100 mm in the x-direction of FIG. 9 is necessary for the elastic member 305 in a contracted state, a composite textile sheet 301a that is from 150 mm to 500 mm when the elastic member 305 is stretched is used. Taking the shrinkage ratio (catalog value and theoretical value) to be one-third, wherein the shrinkage ratio is a percentage of shrinkage due to the restoring force of the elastic member 305 from a state of extension to a prescribed length to a state of the largest contraction, the x-direction dimension of the composite textile sheet 301a in the extended state needs to be 300 mm. This value is obtained by multiplying the inverse number of the shrinkage ratio of the elastic member 305 by the 100 mm dimension that is necessary in the contracted state. However, there are in fact cases in which the shrinkage ratio becomes one-half when the extended state has been canceled by cutting after the first textile sheet 302, the second textile sheet 303, and the textile material sheet 304 have been bonded with the elastic member 305 interposed, or by slowing down the conveyance speed of the conveyance roller. This is attributed to, for example, problems with the temperature and humidity of the manufacturing plant, and particularly to a case in which temperature control is not implemented, and the air temperature is low, problems with the elastic member 305 unit (for example, residual strain of the elastic member 5), and a decrease in the contraction of the elastic member 305 due to curing of the adhesive 307 coated onto the elastic member 305 and the resulting rigidity of the textile material sheet 304. In addition, an application condition of the adhesive 307 (such as the application temperature, application amount, and viscosity) may also be considered to have an effect.

Therefore, the composite textile sheet 301a is heated by a heating device 414, and the residual strain of the elastic member 305 removed by annealing. Thus, the shrinkage ratio of the elastic member 305 approaches the theoretical value. The heating device 414 is, for example, a non-contact type heating device that supplies air of a temperature from 30° C. to 80° C. In the heating treatment, the composite textile sheet 301a is conveyed in an extended state. Non-contact heating by the heating device 414 is performed as the heating treatment in the present embodiment, but contact heating may also be performed in which a heating roller (not illustrated) is made to contact the composite textile sheet 301a.

Such heating treatment described above may further improve bonding of the first textile sheet 302, the second textile sheet 303, and the textile material sheet 304, and prevent the occurrence of issues such as wrinkles and bonding detachment. This can also be applied to the manufacturing of the composite textile sheet 301b described below.

### Step S3: Manufacturing the Composite Textile Sheet 301b

The textile material sheet 304 wound on a sheet roll 404a is conveyed in the X-direction, and is embossed by a pair of embossing rollers 410a, or in other words, is subjected to a mechanical softening treatment. The textile material sheet 304 wound onto the sheet roll 404b may be printed in advance. The textile material sheet 304 that has passed through the embossing rollers 410b is coated with the adhesive 307 by the adhesive application device 411 to be bonded with the second textile sheet 303.

The second textile sheet 303 wound on a sheet roll 403a is conveyed to the negative side (downward) in the Z-direction by a conveyance roller 412c, and is bonded through pressing rollers 413c with the textile material sheet 304 onto which the hot-melt adhesive was applied. Next, the textile material sheet 304 is coated with the adhesive 307 by the adhesive application device 411 to be bonded with the first textile sheet 302.

The first textile sheet 302 wound on a sheet roll 402b is bonded to the bonded body of the second textile sheet 303 and the textile material sheet 304 using the pair of pressing rollers 413d. Thus, the composite textile sheet 301b is manufactured. In a case where the composite textile sheet 301a and the composite textile sheet 301b are of the same configuration, the part of manufacturing the composite textile sheet 301b may be omitted to simplify the manufacturing process 400.

### Step S4: Bonding Between the Composite Textile Sheet 301a and the Composite Textile Sheet 301b

The composite textile sheet 301a and the composite textile sheet 301b are pressed by a pressing roller 413e, and the composite textile sheet 301b is thereby positioned on the composite textile sheet 301a. In this state, the composite textile sheet 301a and the composite textile sheet 301b are not bonded. A bonding device 415 then bonds the composite textile sheet 301a and the composite textile sheet 301b by a bonding method such as heat sealing or ultrasonic welding. In the present embodiment, bonding that is tailored to the exterior form of the glove 310 (310a) is performed. In bonding by the bonding device 415, a bonding margin is included in light of cutting errors in a cutting step described below. With the bonding device 415, bonding using an adhesive, or bonding through sewing may be performed. Note that in the present embodiment, a case was described in which the composite textile sheet 301a includes the elastic member 305, but including the elastic member 305 is not required. That is, the composite textile sheet 301b may be used in place of the composite textile sheet 301a.

### Step S5: Cutting

The composite textile sheet 301a and composite textile sheet 301b that have been bonded in a manner tailored to the exterior form of the glove 310 are cut by a cutting device 416 having a cutter, and thereby, the glove 310 is manufactured. In the present embodiment, cutting is performed after the composite textile sheet 301a and the composite textile sheet 301b have been bonded, but this order may be reversed. In addition, heat from heat sealing may be used for cutting when bonding the composite textile sheet 301a and the composite textile sheet 301b through heat sealing. Furthermore, bonding and cutting of the composite textile sheet 301a and the composite textile sheet 301b may be performed using a seal cutter that is a combination of ultrasonic welding and a cutter. In this case, bonding between the composite textile sheet 301a and the composite textile sheet 301b and cutting can be performed simultaneously, and therefore the efficiency of manufacturing the glove 310 can be improved.

### Fourth Embodiment

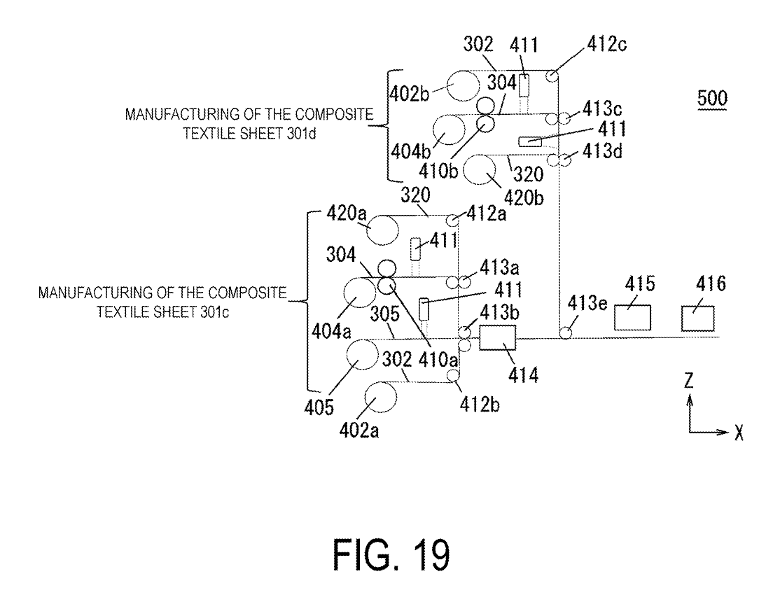

Next, a raincoat as a disposable textile product is described. Note that in the present embodiment, the same reference signs are assigned to elements having the same configurations as those of the above-described second and third embodiments, and the descriptions thereof are omitted. FIG. 18 is an image illustrating an example in which a composite textile sheet 301c and a composite textile sheet 301d are bonded to form a raincoat 311. The composite textile sheet of the second embodiment may be used, as appropriate, as the composite textile sheet 301c. The composite textile sheet 301c illustrated in the examples of FIGS. 18 and 19 is formed through a composite textile sheet that is obtained by laminating the first textile sheet 302, the elastic member 305, the textile material sheet 304, and a moisture permeable film 320, which is a moisture permeable member, in this order from the skin surface of the wearer. The composite textile sheet 301c is not limited to this example, and the composite textile sheet of the first embodiment may be used, as appropriate.

The composite textile sheet of the first embodiment is used as composite textile sheet 301d. As illustrated in FIG. 19 as well, the composite textile sheet 301d is configured by laminating the first textile sheet 302, the textile material sheet 304, and the moisture permeable film 320, in this order from the skin surface of the wearer. In addition, the composite textile sheet 301d may be configured by laminating the first textile sheet 302, the textile material sheet 304, and the second textile sheet 303 in this order from the skin surface of the wearer. The composite textile sheet of the second embodiment may be also used as the composite textile sheet 301d. This composite textile sheet 301d can be specifically realized by providing the elastic member 305 between the first textile sheet 302 and the textile material sheet 304, or between the textile material sheet 304 and the second textile sheet 303. Moreover, the composite textile sheet 301c and the composite textile sheet 301d can have the same configuration.

FIG. 18 illustrates an embodiment of the raincoat 311. While not specifically illustrated, in a case where the composite textile sheet 301c and/or 301d used as the fabric of the raincoat 311 is the composite textile sheet of the second embodiment, the composite textile sheet is preferably disposed such that the elastic member 305 expands and contracts in the X-direction of FIG. 18. This is because by doing so, the raincoat 311 can be configured to fit the body of the wearer. However, a configuration in which the elastic member 305 is disposed to expand and contract in the Y-direction is not excluded. Note that in a case where the composite textile sheet 301c and/or the 301d is the composite textile sheet of the second embodiment, the elastic member 305 may be disposed along the Y-direction in FIG. 18 at least at a portion of the composite textile sheet that is used as the fabric of the raincoat 311 such that a portion of the raincoat 311 expands and contracts in the Y-direction. In the raincoat 311, a first textile sheet 302 having good air permeability is disposed at the skin surface side of the composite textile sheet, and the textile material sheet 304 is disposed on the first textile sheet 302 with the elastic member 305 interposed therebetween. Thus, even in a case where the wearer sweats, the sweat is quickly transmitted to the textile material sheet 304, and the sweat can be absorbed by the textile material sheet 304. Therefore, compared to a raincoat in the related art, the raincoat 311 of the fourth embodiment exhibits an action effect of providing good wearing comfort without the wearer experiencing stuffiness. Moreover, the moisture permeable film 320 releases humidity to the outside, and can prevent the penetration of rain from the outside, and therefore the wearer can comfortably wear the raincoat 311.

FIG. 19 is a schematic view illustrating a manufacturing process 500 for the raincoat 311. Descriptions of the parts that duplicate the manufacturing process 400 described above are omitted. The differences between the composite textile sheet 301a and the composite textile sheet 301c of the present embodiment described above are that the moisture permeable film 320 that is wound on a film roll 420a is used in place of the second textile sheet 303 that is wound on the sheet roll 402a, and the sheet roll 402a holding the first textile sheet 302 is disposed at a lower part, while the film roll 420a holding the moisture permeable film 320 is disposed at an upper part. The differences between the composite textile sheet 301b and the composite textile sheet 301d are that the moisture permeable film 320 that is wound on a film roll 420b is used in place of the second textile sheet 303 that is wound onto the sheet roll 403b, and the sheet roll 402b holding the first textile sheet 302 is disposed at an upper part, while the film roll 420b holding the moisture permeable film 320 is disposed at a lower part.

By configuring with this type of arrangement, the moisture permeable film 320 of the composite textile sheet 301c and the moisture permeable film 320 of the composite textile sheet 301d are bonding surfaces in the present embodiment. In the embodiments described above, the first textile sheet 302 of the composite textile sheet 301a, and the first textile sheet 302 of the composite textile sheet 301b are bonding surfaces, but using the moisture permeable films 20 themselves as bonding surfaces results in a stronger bonding strength. Thus, a raincoat 311 with improved durability against wind and rain can be realized. Note that bonding of the moisture permeable films 320 themselves results in stronger bonding than bonding of the textile material sheets 304.

In the present embodiment, an additional step is implemented, in which after the moisture permeable film 320 of the composite textile sheet 301c and the moisture permeable film 320 of the composite textile sheet 301d are bonded to form a bonded body, the bonded body is cut, and the front and back sides of the bonded body are turned inside out using an inverting device (not illustrated). Therefore, the moisture permeable films 320 that are bonded at the inner side in the bonded state configure the outside surface when formed into the raincoat 311. Note that as the inverting device, various methods can be used such as a method that inverts the composite textile sheets 301c, 301d using a mechanical arm.

As described above, the moisture permeable films 320 are bonded at the inner side and then turned inside out in this manner, and the moisture permeable films 320 are at the outside of the raincoat 311 when worn, and the bonding surface is at the inner side. Therefore, the bonding strength of the composite textile sheets 301c, 301d is increased, and a raincoat 311 with a good external appearance can be realized. In the manufacturing of the above-described glove 310 (310a) as well, the moisture permeable film 320 may be used in place of the second textile sheet 303, and an inverting step that uses an inverting device or the like may be added, to provide a glove 310 (310a) having a moisture permeable film at the outer side and the bonding surface at the inner side.

As described above, in the examples of FIGS. 18 and 19, a step of bonding the composite textile sheet 301d and the composite textile sheet 301c is implemented when manufacturing the raincoat 311. For the raincoat 311, by changing, as appropriate, not only the bonding of the composite textile sheet 301d and the composite textile sheet 301c, but also the component design of the raincoat 311, in some cases a step of bonding the composite textile sheets 301d themselves and the composite textile sheets 301c themselves may be implemented. For example, for the raincoat 311 illustrated in the examples of FIGS. 18 and 19, in some cases, the portion that forms a single composite textile sheet 301d may be split into a plurality of portions and made into components, and the various components may be bonded.

This type of bonding of the composite textile sheet 301d and the composite textile sheet 301c, and bonding of composite textile sheets 301d themselves and of composite textile sheets 301c themselves can be realized through the bonding device 415 illustrated in FIG. 19. As the bonding device 415, as presented in the explanation of the third embodiment, methods such as heat sealing and ultrasonic welding can be selected, as appropriate, but a method of ultrasonic welding using an ultrasonic sewing machine can be favorably used.

It is important that the raincoat 311 suppress as much as possible the penetration of rain through the bonded sections including the bonded section between the textile sheet 301d and the composite textile sheet 301c, the bonded sections of composite textile sheets 301d themselves, and bonded sections of the composite textile sheets 301c themselves. Regarding this point, the penetration of water through the bonded sections can be effectively suppressed by an ultrasonic welding method that uses an ultrasonic sewing machine. According to the ultrasonic welding method that uses an ultrasonic sewing machine, bonding can be realized with an appropriate pattern such as linear bonding and bonding in intermittent lines. In particular, with a pattern of a plurality (a quantity from 2 to 4 for example) of parallel intermittent lines with intermittent portions that are not parallel, the penetration of water at the bonded sections can be suppressed while allowing the passage of air.

Note that in the present embodiment, a raincoat provided with a front bodice and a back bodice was primarily envisioned and described, but the present invention is not limited thereto. For example, the raincoat may also be a so-called poncho type, and in this case, the raincoat is formed from a single composite textile sheet. As this composite textile sheet, the composite textile sheets 301c, 301d presented in the present embodiment can be used.

### Fifth Embodiment

Next, underpants as a disposable textile product are described. The embodiment illustrated in FIG. 3 is an example of underpants as a disposable textile product, but underpants of another embodiment are illustrated in FIG. 20. Note that in the present embodiment, the same reference signs are assigned to elements having the same configurations as those of the above-described embodiments, and the descriptions thereof are omitted. FIG. 20 illustrates an example in which similar to the glove 310, the composite textile sheet 301a and the composite textile sheet 301b are used as disposable underpants 312. In the disposable underpants 312, the composite textile sheet 301b configures the front side and the back side, and the composite textile sheet 301a bonds the front side composite textile sheet 301b and the back side composite textile sheet 301b. In addition, the torso fitting section 313 is configured by the composite textile sheet 301b.

The composite textile sheet 301a uses the composite textile sheet of the second embodiment, and has a multi-layered structure that is formed by laminating the first textile sheet 302, the elastic member 305, the textile material sheet 304, and the second textile sheet 303 in this order from the inner side (skin surface side). The composite textile sheet 301a may use the moisture permeable film 320 in place of the second textile sheet 303, or may be a structure in which the moisture permeable film 320 is layered to the non-skin surface side of the multi-layered structure.

The composite textile sheet 301b uses the composite textile sheet of the first embodiment, and has a multi-layered structure that is formed by laminating the first textile sheet 302, the textile material sheet 304, and the second textile sheet 303 in this order from the inner side (skin surface side). The composite textile sheet 301b may use the moisture permeable film 320 in place of the second textile sheet 303, or may be a structure in which the moisture permeable film 320 is layered to the multi-layered structure. In the present embodiment, the composite textile sheet of the first embodiment is used as the composite textile sheet 301b, but the present invention is not limited thereto, and the composite textile sheet of the second embodiment may also be used. That is, the elastic member 305 may be further provided in the composite textile sheet 301b. A specific example of the position at which the elastic member 305 is provided is between the first textile sheet 302 and the textile material sheet 304. In addition, while not illustrated, the textile material sheet 304 can be printed to thereby improve the design aspect of the disposable underpants 312.

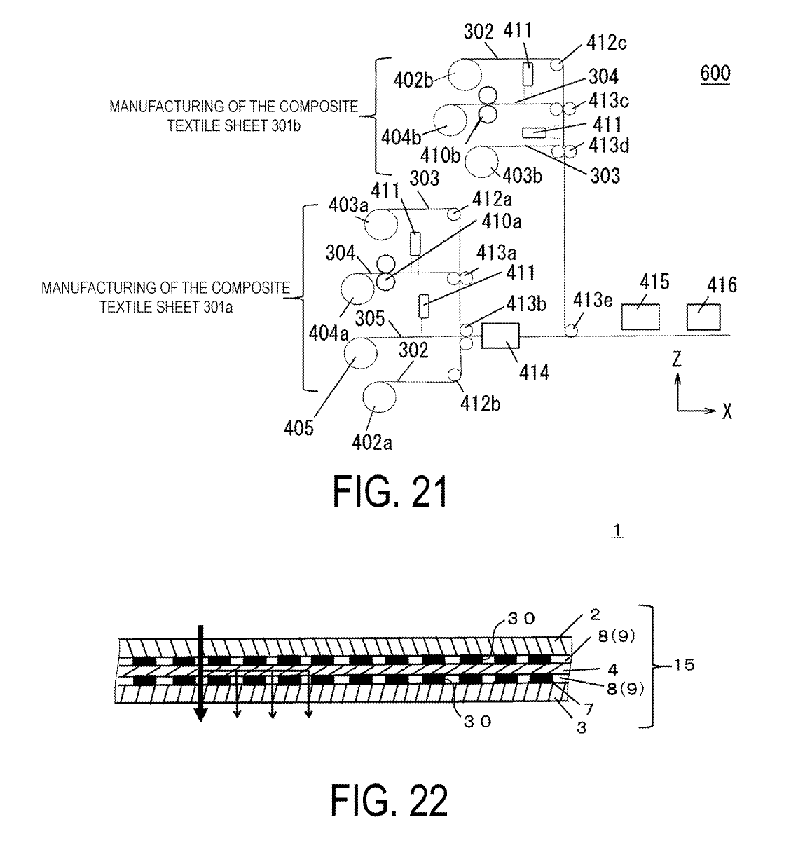

FIG. 21 is a schematic view illustrating a manufacturing process 600 for the underpants 312. Descriptions of the parts that duplicate the manufacturing process 400 (FIG. 16) described above are omitted. The manufacturing process 600 differs from the manufacturing process 400 in that the arrangement of the first textile sheet 302 and the second textile sheet 303 is different in the manufacturing of the composite textile sheet 301a and the composite textile sheet 301b. By differing the arrangement thereof, the bonding surface between the composite textile sheet 301a and the composite textile sheet 301b is at the inner side (skin surface side) of the underpants 312, the bonding surface is not exposed to the outside, and the design aspect of the underpants 312 can be improved.

### Sixth Embodiment

In the sixth embodiment, a sheet as a disposable textile product is described. As a disposable textile product, the sheet uses the composite textile sheet of the first embodiment and/or the composite textile sheet of the second embodiment as fabric, and this fabric can then be cut to an appropriate dimension and used. However, from the perspective of being able to achieve more stable dimensions of the fabric, use of the composite textile sheet of the first embodiment is preferable. From the perspective of being able to form a sheet with thickness and elasticity, use of the composite textile sheet of the second embodiment is preferable.

In this manner, a fabric made from the composite textile sheet of the first embodiment, or a composite textile sheet of the second embodiment is favorably selected in accordance with the required properties of the sheet based on conditions such as the purpose of the sheet. Furthermore, the textile sheets configuring the composite textile sheet and the attributes such as the material of the textile material sheet may be appropriately selected. From the viewpoint that the sheet suitably exhibits absorbency of moisture such as sweat at the surface that is in contact with the skin surface, and suppresses the penetration of water to the surface that is not in contact with the skin surface, in a case where the first textile sheet 2 is used as the surface that is in contact with the skin surface, the composite textile sheets like those illustrated by the examples of FIGS. 23A and 23B are preferably adopted.

The glove 310, raincoat 311, underpants 312, and sheet described above as disposable textile products are disposable types, but can withstand washing multiple times, and therefore are economical, can contribute to resource savings, and can be configured with consideration of the environment. In addition, the glove 310, raincoat 311, underpants 312, and sheet can be used regardless of age (can be configured for children and for adults), gender (for male use, for female use), or body shape, and can also be adopted for pets or other animals.

The composite textile sheets of each of the above-described embodiments have a basic structure in which a textile sheet (nonwoven fabric) is partially bonded to a textile material sheet (paper material), and excel in moisture transpiration property. From the perspective of having an excellent moisture transpiration property in this manner, the composite textile sheet of each of the embodiments may be considered as a material having the same qualities and same effects as those of a paper material. While paper material lacks softness, however, the composite textile sheet of each of the embodiments exhibit abundant softness, and from that viewpoint, the composite textile sheet can be perceived as being a new paper material that are obtained by adding the property of softness to a paper material. In other words, the composite textile sheet can be referred to as a new type of paper material with improved properties obtained by combining with a textile sheet (nonwoven fabric).

### EXAMPLES

The present invention will be explained hereinbelow in greater detail through the presentation of specific examples of the composite textile sheet according to the embodiments of the present invention.

### Example 1

A composite textile sheet of Example 1 was configured by laminating a first textile sheet, a textile material sheet, a moisture permeable film, and a second textile sheet in that order. In Example 1, a hydrophilic spunbonded nonwoven fabric (basis weight of 15 g/m²) was used as the first textile sheet, and as the textile material sheet, paper of 100% pulp (paper sheet for tissue paper: basis weight of 13 g/m²) was used as is without printing. An opalescent film (basis weight of 18 g/m²) was used as the moisture permeable film, and a water-repellent spunbonded nonwoven fabric (basis weight of 15 g/m²) was used as the second textile sheet. These sheets were adhered using a hot-melt adhesive (total basis weight of the hot-melt adhesive of 1.2 g/m²), and a multi-ply sheet having a total basis weight of 62.2 g/m² was obtained and used as the composite textile sheet of Example 1.

### Example 2

A composite textile sheet of the same layer configuration as that of Example 1 was used, printing was carried out on the textile material sheet (paper), and the resulting multi-ply sheet was used as the composite textile sheet of Example 2.

### Example 3

The composite textile sheet of Example 3 also had the same layer configuration as that of Example 1. In Example 3, a water-repellent spunbonded nonwoven fabric (basis weight of 15 g/m²) was used as the first textile sheet, and as the textile material sheet, paper of 100% pulp (paper sheet for tissue paper: basis weight of 13 g/m²) was used without printing. An opalescent film (basis weight of 18 g/m²) was used as the moisture permeable film, and a water-repellent spunbonded nonwoven fabric (basis weight of 40 g/m²) was used as the second textile sheet. These sheets were adhered using a hot-melt adhesive (total basis weight of the hot-melt adhesive of 1.2 g/m²), and a multi-ply sheet having a total basis weight of 87.2 g/m² was obtained and used as Example 3.

### Example 4

A composite textile sheet of Example 4 was configured by laminating a first textile sheet and a textile material sheet. In Example 4, a water-repellent spunbonded nonwoven fabric (basis weight of 15 g/m²) was used as the first textile sheet, and as the textile material sheet, paper of 100% pulp (paper sheet for tissue paper: basis weight of 13 g/m²) was used without printing. These sheets were adhered using a hot-melt adhesive (total basis weight of the hot-melt adhesive of 1.2 g/m²), a multi-ply sheet having a total basis weight of 29.2 g/m² was obtained and used as the composite textile sheet of Example 4.

### Comparative Example 1

A composite textile sheet of Comparative Example 1 was configured by laminating a first textile sheet, a moisture permeable film, a textile material sheet, and a second textile sheet in this order. In Comparative Example 1, a water-repellent spunbonded nonwoven fabric (basis weight of 15 g/m²) was used as the first textile sheet, and an opalescent film (basis weight of 18 g/m²) was used as the moisture permeable film. In addition, as the textile material sheet, paper of 100% pulp (paper sheet for tissue paper: basis weight of 13 g/m²) was used without printing, and a hydrophilic spunbonded nonwoven fabric (basis weight of 15 g/m²) was used as the second textile sheet. These sheets were adhered using a hot-melt adhesive (total basis weight of the hot-melt adhesive of 1.2 g/m²), and a multi-ply sheet having a total basis weight of 62.2 g/m² was obtained and used as Comparative Example 1.

The moisture absorption property (transpiration ratio) of each of the multi-ply sheets of Examples 1 to 4 and Comparative Example 1 was evaluated. The moisture absorption property (transpiration property) was evaluated through a comprehensive evaluation of both the water absorbency and the quick drying ability by performing a transpiration property (ii) test (Boken standard BQEA028). A test piece with a diameter of approximately 9 cm was fabricated for each of the multi-ply sheets of Examples 1 to 4 and Comparative Example 1, and the mass (W) of each test piece and a petri dish were measured. Next, 0.1 mL of water was dropped onto the petri dish, the test piece was placed thereon, and the mass (W0) was measured. The petri dish with the test piece was left in a standard environment (20° C., humidity of 65% RH), and the mass (Wt) was measured after each predetermined interval of time (5 min, 10 min, and every 10 minutes thereafter until a time of 60 minutes was reached). The transpiration ratio (%) at each predetermined period of time was then calculated from the measured masses W, W0, and Wt using the following Equation (1). The results are shown in Table 1.

Equation 1

Transpiration Ratio (%)={(W0−Wt)/(W0−W)}×100 (1)

TABLE 1

| | Transpiration Ratio (%) | | | | | | |
|---|---|---|---|---|---|---|---|
| | 5 | 10 | 20 | 30 | 40 | 50 | 60 |
| | min | min | min | min | min | min | min |
| Example 1 | 12.6 | 27.8 | 59.8 | 84.1 | 95.4 | 97.6 | 98.4 |
| Example 2 | 10.2 | 23.2 | 50.5 | 74.4 | 89.9 | 96.2 | 98.2 |
| Example 3 | 10.5 | 23.7 | 49.3 | 74.4 | 91.3 | 97.2 | 98.0 |
| Example 4 | 21.9 | 43.7 | 83.5 | 98.2 | 98.3 | 98.5 | 99.0 |
| Comparative | 1.2 | 1.6 | 3.7 | 5.2 | 7.3 | 8.9 | 10.2 |
| Example 1 | | | | | | | |

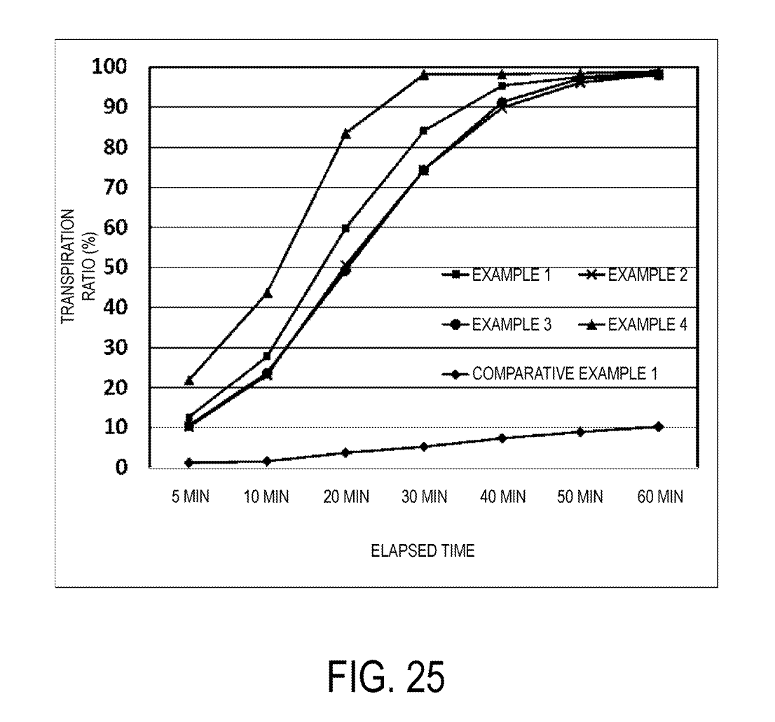

As is clear from the transpiration ratio results shown in Table 1 (see the graph of FIG. 25), in Comparative Example 1, the transpiration ratio was 15% or less even after 60 minutes, but in Examples 1 to 4, the transpiration ratios exceeded 20% after 10 minutes, and exceeded 40% after 20 minutes, and thereafter, the transpiration ratios exceeded 70% after 30 minutes, exceeded 85% after 40 minutes, exceeded 95% after 50 minutes, and exceeded 98% after 60 minutes.

As a criterion for evaluation with respect to the Boken standard BQEA028, in sports applications, the transpiration ratio 20 minutes after beginning testing is preferably 50% or higher for a textile product and 40% or higher for a knitted product, and in general applications, the transpiration ratio is preferably 40% or higher for a fabric product and 30% or higher for a knitted product. Therefore, because a transpiration ratio of 40% or higher can be obtained with the sheet material of Example 1, it can be said that such material can be comfortably worn both in sports applications and general applications. Thus, it is clear that the composite textile sheets of the present examples made from the multi-ply sheets of Examples 1 to 4 have a very high moisture absorption property (transpiration ratio).

The total basis weight of the multi-ply sheet is set from 50 g/m² to 100 g/m² by adjusting the basis weights of the first textile sheet and the second textile sheet, for example, and the high moisture absorption property (transpiration ratio) as described above can be obtained.

Furthermore, the transpiration performance (ii) test (Boken method) for evaluating the moisture absorption property of fabric was applied to ISO17617. When the above-described data of Table 1 was applied to this test method, data as shown in the following Table 2 was obtained.

TABLE 2

| | Example | Example | Example | Example | Comparative |
|---|---|---|---|---|---|
| | 1 | 2 | 3 | 4 | Example 1 |
| Drying | 2.87 | 2.34 | 2.36 | 4.17 | 0.17 |
| rate | | | | | |
| Drying | 35.0 | 42.6 | 42.3 | 23.8 | 57.9 |
| time | | | | | |

In Table 2, the unit for the drying rate (increase in transpiration ratio per unit time) is %/minute, and the unit for the drying time (time until the transpiration ratio reaches 100%) is minutes. From Table 2, it is clear that the multi-ply sheets of Examples 1 to 4 have a drying rate of 2.0 or higher and a drying time of 50 minutes or less.

Embodiments of the present invention were presented and described above, but the scope of the present invention is not limited to the descriptions of the embodiments, and various modifications and appropriate combinations can be made. That is, the technical scope of the present invention is not limited to the scope described in the abovementioned embodiments. It would be clear to a person skilled in the art that various modifications and improvements can be added to the abovementioned embodiments. It is also clear from the description of the claims that aspects obtained by adding these types of modifications and improvements can also be included in the technical scope of the present invention.

### REFERENCE SIGNS LIST

1, 300, 301a, 301b, 301c, 301d: Composite textile sheet
2, 302: First textile sheet
3, 303: Second textile sheet
4, 304: Textile material sheet
8, 308: Non-bonded region
9, 309: Space section
15, 315: Multi-ply sheet
30, 330: Bonded region

1. A composite textile sheet, comprising:
a textile sheet having air permeability; and
a textile material sheet having liquid diffusibility
and contacting the textile material sheet,
wherein the textile sheet and the textile material sheet are partially bonded at a first bonded region and partially not bonded at a first non-bonded region,
the first non-bonded region includes a first space section, and
the first space section, a first gap between fibers in the textile sheet, and a second gap between fibers in the textile material sheet mutually communicate such that a moisture transpiration path is formed in a composite of the textile sheet and the textile material sheet.

2. The composite textile sheet according to claim 1, further comprising:
a moisture permeable film contacting the textile material sheet on a side opposite to the textile sheet,
wherein the textile material sheet and the moisture permeable film are partially bonded at a second bonded region and partially not bonded at a second non-bonded region, and
the second non-bonded region includes a space section.

3. The composite textile sheet according to claim 1, further comprising:
a second textile sheet such that the textile material sheet is provided between the textile sheet and the second textile sheet,
wherein the textile material sheet and the second textile sheet are partially bonded at a third bonded region and partially not bonded at a third non-bonded region,
the third non-bonded region includes a space section, and
the space section of the third non-bonded region is connected to the moisture transpiration path.

4. The composite textile sheet according to claim 3, further comprising:
a moisture permeable film contacting the second textile sheet on a side opposite to the textile material sheet,
wherein the second textile sheet and the moisture permeable film are partially bonded at a fourth bonded region and partially not bonded at a fourth non-bonded region, and
the fourth non-bonded region includes a space section.

5. The composite textile sheet according to claim 1, wherein the composite of the textile sheet and the textile material sheet has a moisture absorption property.

6. The composite textile sheet according to claim 5, wherein the composite exhibits a transpiration ratio of 40% or greater after 20 minutes from initiation of a transpiration performance (ii) test of a Boken quality evaluation test.

7. The composite textile sheet according to claim 6, wherein the composite exhibits a drying rate of 2.0 or greater and a drying time of 50 minutes or less in an ISO17617 transpiration performance (ii) test.

8. The composite textile sheet according to claim 3, further comprising:
an elastic member between the first textile sheet and the textile material sheet, the elastic member imparting stretchability to the composite textile sheet.

9. The composite textile sheet according to claim 1, wherein printing is applied on the textile material sheet.

10. The composite textile sheet according to claim 1, wherein an area of the first bonded region is from 50% to 90% of an area of the textile sheet.

11. The composite textile sheet according to claim 1, wherein the textile sheet comprises a nonwoven fabric material.

12. The composite textile sheet according to claim 1, wherein the textile material sheet comprises a paper material.

13. A disposable textile product, comprising:
the composite textile sheet of claim 1.

14. A glove, comprising:
a first composite textile sheet comprising the composite textile sheet of claim 8; and
a second composite textile sheet comprising a first textile sheet, a textile material sheet, and a second textile sheet.

15. A raincoat, comprising:
a first composite textile sheet comprising a first textile sheet, a textile material sheet, and a moisture permeable film; and
a second composite textile sheet comprising the composite textile sheet of claim 2.

16. A method for manufacturing a disposable textile product, the method comprising:
manufacturing a first composite textile sheet by supplying each of a textile sheet having air permeability and a textile material sheet having liquid diffusibility, and partially bonding the first composite textile sheet and the textile material sheet;
manufacturing a second composite textile sheet by supplying each of a textile sheet having air permeability and a textile material sheet having liquid diffusibility, and partially bonding the first composite textile sheet and the textile material sheet;
bonding the first composite textile sheet and the second composite textile sheet; and
cutting to a prescribed shape,
wherein the cutting is performed simultaneously with or after the bonding.
